(19) United States
(12) Patent Application Publication
(10) Pub. No.: US 2008/0306750 A1
(43) Pub. Date: Dec. 11, 2008

(54) EMPLOYMENT SCREENING SYSTEM AND METHOD

(75) Inventors: Casey Wunder, Denver, CO (US); Robert Piecuch, Wellington, CO (US); Michelle H. Oldham, Fort Collins, CO (US); Kathryn M. Carlson, Fort Collins, CO (US); Mark T. Seib, Johnstown, CO (US); Tracy R. Nicolls, Windsor, CO (US); Jason C. Campbell, Fort Collins, CO (US); Margaret Launer, Windsor, CO (US)

Correspondence Address: ICE MILLER LLP, ONE AMERICAN SQUARE, SUITE 3100, INDIANAPOLIS, IN, 46282-0200, US

(73) Assignee: ADP, Inc., Roseland, NJ (US)

(21) Appl. No.: 11/760,512

(22) Filed: Jun. 8, 2007

(51) Int. Cl. G06Q 10/00

(52) U.S. Cl. 705/1

(57) ABSTRACT

A system and method for screening candidates for compliance with general, employer specific, and/or position specific policies. Such policies may be applicable to job applicants, potential contractors, existing employees, and/or existing contractors (collectively, “candidates”), and may be influenced by law or by best practices. The system compiles data based on the policies from both automatic and other data sources. The system also automatically rates the results of the data compiled. Through the use of the system, employers may easily obtain relevant information about candidates prior to engagement or during engagement of the candidate and without the requirement that the employer manually analyze screening results.

### FIELD OF THE INVENTION

This invention relates to a system and method for employment, and, more particularly to a system and method for screening candidates, consultants, and employees to meet certain criteria.

### BACKGROUND OF THE INVENTION

Employers strive to hire and retain employees who will make significant contributions during their employment. Background screening is one task in the hiring process that helps to ensure that qualified candidates are selected for positions with the employer. Thus, it is common for some employers to hire third party vendors to run background checks on job applicants. Such third party vendors typically run various searches (e.g., criminal history search, motor vehicle record search, credit checks, etc.) in order to collect a job applicant's relevant background information. Such background information is compiled into detailed reports based on prerequisites established by the employer. The employer then reviews the reports, performing extensive analysis thereof, to determine if the candidate satisfies its requirements for employment for a particular position.

Generally, the analysis of background checks is performed manually. The manual analysis is required because it is usually necessary to compare the standard report results provided by the third party vendor against several different standards, including the employer's policies, applicable federal, state, and local laws, and best practices, such as those best practices established by a trade association or industry group. Accordingly, the manual analysis of the reports is highly labor intensive, is subject to error, and may be inconsistent due to human subjectivity in the analysis. Therefore, it is desired to provide a system and method for background checking of job applicants that produces an automatic, consistent result in determining whether the candidate meets the employer's hiring policies and/or applicable federal and state laws.

For some employers, background checks have become a matter of course in considering candidates for some or all of the positions within the company. However, due to the manual labor required and the potential for error or inconsistency, when engaging contractors, most employers simply require the contractor to attest in the contract with the contractor that the contractor (and the contractor's employees, if applicable) meet the employer's policies of the type related to the background checks. For example, such a contract may specify that each person used by the contractor on the project with the employer has passed a drug test or has not been found guilty of a felony.

While such a contractual provision gives the employer the ability to sue the contractor in the event of breach, it does not necessarily protect the employer from engagement of a contractor who is not suitable in the employer's view, or in the view of applicable federal or state laws. For example, consider the situation in which an employer needs to hire temporary workers for a day care center, and state law prohibits the engagement of any person in a licensed day care center to be a child molester, as such terms is defined in state law. If a contractor attests to the fact that its employees have not been found guilty of child molestation, but, nevertheless, uses a person who is a child molester, the employer is likely to lose its license to operate as a day care, and may be subject to additional liability for acts of molestation by that person while engaged by the employer. Thus, it is desired to provide a system and method for background checking that can be utilized for proposed contracting personnel. As with the system and method for job candidates, it is desirable that such a system and method avoid the requirement for manual analysis of the contractors in view of the desired criteria.

Because of the effort required for background screening, employers have a tendency not to check its employees' backgrounds after they have been hired. The failure to check the background of any employee after employment could be catastrophic. Consider, for example, employment of an individual at manufacturing facility that uses dangerous chemicals in the manufacturing process, with the use and distribution of such chemicals strictly regulated by federal authorities. Under such regulations, persons who transport the dangerous chemicals must have a valid driver's license and cannot be listed on any federal terrorist list. It is possible that an employee may have met the employer's hiring policies and federal law at the time he/she was hired, but later, unknown to the employer, the employee may have had his/her driver's license revoked or be included on a terrorist list. Similarly, consider the bank who engages an employee who passed all the hiring policies of the bank upon hiring, but was later, unknown to the employer, found to be guilty for forgery for a matter unrelated to his/her employment with the bank. It is desirable to provide a system and method for background checking, i.e., for checking an individual against desired policies and/or laws, that is simple and cost-effective so as to permit an employer to check its employees and/or its engaged contractors during the employment/engagement of such persons. It is also desirable to accommodate policies other than “hiring” policies, as the requirements for continued employment/engagement or for promotion may not necessarily be the same as the applicable policies for hiring/engaging a particular individual.

Implicit in the above remarks is the desire to perform a myriad of different types of screening in background screening. Such screening may include, for example, consumer-related information, criminal history, regulatory requirements, and much more. Criminal reports may differ from jurisdiction to jurisdiction, and may also be difficult to analyze. Similarly, consumer reports provided as a result of background screening can be complex or time consuming to read and decipher to determine whether a candidate is qualified under the employer's policy(ies). As to regulatory requirements, each federal, state, or local agency's information is likely to be specific to that agency and difficult and/or time consuming to analyze. Types of disparate regulations and best practices include, for example, those of the Federal Trade Commission as related to the Fair Credit Reporting Act; local, state, and federal government regulations for candidate screening for certain types of positions; federal, state, and local employment commissions; and guidelines or best practices, such as the human resource guidelines of the Society for Human Resource Management.

Therefore, it is desired to provide a system and method for consistent reporting of qualifications based on a wide variety of data sources—the sources of the data for criteria searched. In this manner, the analysis of the data will be much easier for the employer. Further, it is desired to automate the process of analyzing the data collected in view of the applicable policies and applicable law.

Thus, in considering the job applicant, contractor, and employee, and to permit for the application of various criteria of concern in background checking for these individuals, it is desirable to provide an automated process through which the collected information is automatically compared against predefined parameters. It is also desired that the system and method for screening be implemented in a manner to allow an employer to quickly assess whether or not a candidate job applicant, contractor (proposed or already engaged), employee, and the like) meets certain employment/engagement criteria.

### SUMMARY OF THE INVENTION

The system and method of the present application permits for screening of job candidates, employees, contractors, and the like for qualification to be hired, engaged, promoted, or retained by the employer. Such qualification is based on one or more policies of the employer. These policies of the employer may be based on general rules, rules established by the employer generally, rules established by the employer for specific positions, and/or rules established by law or by recommended best practices. The rules established by law and or best practices may be incorporated into general rules, employer specific rules, and/or position specific rules. Such best practices may be those promulgated by trade associations, for example. Such policies may also differ for hiring than for retention or for promotion of an employee and/or contractor.

Embodiments of the subject invention comprise an automated system for conducting background screening and evaluations. The system is capable of automatically and objectively evaluating a candidate's relevant background information with respect to specified screening policies and acceptance levels configured by the employer. Once a candidate's background information is obtained and categorized with respect to certain predefined criteria, the system rates the collected information relative to employer-defined standards. Thereafter, the system compiles the rating results into a comprehensive report consisting of the different criteria and the determined ratings.

Specifically, the system employs a decision matrix to assess a candidate against employer-defined or selected criteria. The employer is permitted to select the characteristics to be searched as well as the ratings associated with the results of the searches. For example, an employer may indicate that the criteria of the background check must include a criminal history and a credit report. An employer is allowed to choose if it desires to use a standard screening policy or if it prefers a customized screening policy, or any various combinations thereof. If the employer wishes to customize a screening policy, a decision matrix is created based on the employer's standards in its specific screening policies and any applicable laws. The employer can utilize different decision matrices based upon the position for which they are screening. The background checks are then configured into the generated decision matrix and rated according to the applicable standards. Such background checks may include, but are not limited to, criminal history checks, motor vehicle records, social security number validation, credit reports, bankruptcy reports, civil court reports, sexual offender reports, government sanctions registry, and workers' compensation claims reports.

The ratings given to the different criteria or characteristics may comprise the labels: 1) Meets Policy, 2) Indeterminate, or 3) Does Not Meet Policy, as well as similar ratings with alerts. According to one embodiment, a rating of “Indeterminate” indicates that further detail may be necessary on a certain characteristic, thereby denoting that the employer should manually analyze a particular piece of information. In addition, the system is capable of displaying different levels of detail with respect to the reports (results of the searches) and ratings. For example, a first level of ratings may be utilized to initially determine whether or not a job candidate has a criminal history, and, if so, if the criminal history conflicts with the employer's applicable policy(ies). In the event the candidate's report indicates several criminal occurrences, the system may further categorize the criminal occurrences and rate them at a second level, thereby providing further detail with respect thereto (i.e. conviction date, crime detail etc.). Therefore, an employer can immediately differentiate between, for example, a crime of dishonesty and a crime of recklessness, such that the employer can readily determine if the candidate meets its specific hiring policy. Once the background information is rated, the individual ratings may be tallied into one overall rating, such as “Applicant Meets Policy” or “Applicant Does Not Meet Policy”, which is then displayed in a manner that is easily accessible to the employer.

In one embodiment, the system of the present application for evaluating a candidate based on a predetermined policy comprises a processor, data storage media operably connected to the processor, and a data source operably connected to the processor. The data storage media (disk drive, RAM, or other storage media well known in the art) stores data representative of a candidate. The data storage also stores a decision matrix representative of the predefined policy. The decision matrix includes a characteristic for evaluation of the candidate and at least one rating for the characteristic. The at least one rating is based on the characteristic.

The data source of the system, in response to a request from the processor, provides the processor with data representative of the characteristic based on the data representative of the candidate. The processor is capable of comparing the data representative of the characteristic provided by the data source to the characteristic of the decision matrix, and then to determine the corresponding at least one rating for the characteristic based on that comparison.

There are several variations of the system presented herein. Any data source may comprise an instant data source—a computing device having access to one or more databases that is capable of automatically accepting the request for a search from the processor and automatically providing the results of the search for that candidate to the processor. Any data source may comprise a non-instant data source—the combination of an input device for communication with the processor and a remote data source accessed by an intermediary. For a non-instant data source, in response to the request for a search as seen by an intermediary at the input device, the intermediary retrieves the appropriate data from the remote data source and then inputs that data into the input device.

Different types and more than one policy may be stored in the data storage and processed by the processor according to the present application. Such policies are reflected in decision matrices, and may comprise a general policy, an employer specific policy, or a position specific policy. The decision matrices may be established by the system, a user, or both, and may be influenced by applicable law or by best practices.

The system is not limited to handling a single characteristic for any policy. Multiple characteristics may be included in any one policy, and, hence, any one decision matrix stored on the data storage. A single decision matrix may require access to several data sources. Multiple types of ratings, and ratings of combinations of ratings may be established in the decision matrix.

The system of the present application may include a separate user system in bidirectional communication with the processor, such as is often used in what is known as an “application service provider environment”. Alternately, the processor and user system could collectively comprise a computing device, such as often used in a stand alone computing system. In either case, the system requires bidirectional communication of the processor with each data source to send requests for information and to receive information from each data source. Of course, only those data sources having relevant information for the characteristics of the search request will need to be accessed for the requested search.

In one embodiment, the method of evaluating a candidate based on a predefined policy according to the present application utilizes a system of the present application. With the system, the processor retrieves from the data storage media the candidate information and the decision matrix. The processor then sends to the data source a request to search for data representative of the characteristic based on the data representative of the candidate. The data source then provides to the processor the data representative of the characteristic for the candidate. The processor compares the data representative of the characteristic for the candidate as provided by the data source to the characteristic of the decision matrix to determine at least one rating for the characteristic for that candidate.

The system and method of the present application provide an easy to use, configurable screening system. The system can be used to retrieve data available from electronic sources and from non-electronic sources or remote sources. Candidates are automatically rated with the system and method of the present application, thereby eliminating the requirement of the employer to analyze the results of screening searches. The simplicity and convenience of the system from the user's perspective means that the system can be used for purposes other than screening of job applicants. The system is useful for potential contractors, and for checking existing employees and existing contractors for promotion, continued compliance with policies, compliance with new policies, and compliance with changed policies.

### BRIEF DESCRIPTION OF THE DRAWINGS

FIG. 1 shows a schematic diagram of one embodiment of the system for screening candidates according to the present application;

FIG. 2 shows a flow chart of one embodiment of the method of screening candidates according to the present application;

FIG. 3 shows a flow chart of another embodiment of the method of screening candidates according to the present application;

FIG. 4 shows a schematic diagram of one embodiment of the process of rating, correcting ratings, monitoring errors with the rating engine according to the present application;

FIG. 5 shows one embodiment of a sample report resulting from the system for screening candidates according to the present application;

FIG. 6 shows a screen shot of one embodiment of a log-on screen according to the present application;

FIG. 7 shows a screen shot of one embodiment of a screening tools screen according to the present application;

FIG. 8 shows a screen shot of one embodiment of an account settings screen according to the present application; FIG. 9 shows a screen shot of one embodiment of a hiring policy setup screen according to the present application;

FIG. 10 shows another screen shot of an embodiment of a hiring policy setup screen according to the present application;

FIG. 11 shows a screen shot of the embodiment of the account settings screen of FIG. 8 wherein the hiring policy is now enabled;

FIG. 12 shows a screen shot of one embodiment of the action items screen according to the present application;

FIG. 13 shows a screen shot of one embodiment of the screen a new candidate screen according to the present application;

FIG. 14 shows a screen shot of one embodiment of a candidate entry screen according to the present application;

FIG. 15 shows a screen shot of the embodiment of the screen a new candidate screen of FIG. 13 having data filled therein;

FIG. 16 shows a screen shot of the embodiment of the screen a new candidate screen of FIG. 15 indicating that results have been determined for certain of the candidates;

FIG. 17 shows a screen shot of one embodiment of an order screen according to the present application;

FIG. 18 shows a screen shot of the embodiment of the screening tools screen of FIG. 7 showing the status of candidate screening; and

FIG. 19 shows a screen shot of screening search results for a particular candidate according to one embodiment of the invention.

### DETAILED DESCRIPTION OF PREFERRED EMBODIMENTS

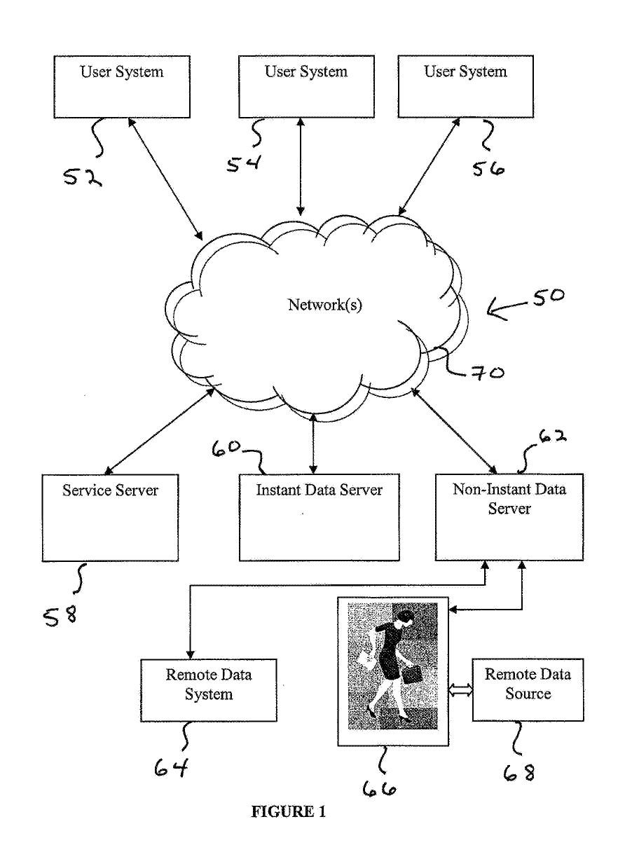

Referring now to FIG. 1, there is shown a schematic diagram of one embodiment of the system for screening candidates according to the present application. In this embodiment, system 50 includes first user system 52, second user system 54, and third user system 56. System 50 also includes service server 58, instant data server 60, non-instant data server 62, remote data system 64, intermediary 66, and remote data source 68. Each of first user system 52, second user system 54, third user system 56, service server 58, instant data server 60, and non-instant data server 62 are in bidirectional communication with network 70.

First, second, and third user systems 52, 54, and 56, respectively, each comprise terminal devices used by employers to log onto, establish an account, establish settings, enter data, and retrieve results from service server 58. Data entered at first, second, and third user systems 52, 54, and 56, respectively, is also received at service server 58 via network 70. Such terminal devices include computers, terminals, personal data assistants, telephones (both wired and wireless), and other devices capable of receiving input and presenting results to a user. Input may be made by keyboard, voice recognition, or other input mechanisms well known in the art. Presentation of results may be made on a display, in print, orally, or by other output devices well known in the art. Network 70 comprises one or more networks facilitating bidirectional communication between the devices connected to network 70. Thus, network 70 may include the internet, local area networks, wide area networks, infrared communications networks, other wireless networks, and/or satellite networks, for example.

Service server 58 comprises one of more computing devices operated by a service provider. By service server 58, the service provider is making the service of candidate screening available to employers. Service server 58 comprises or is connected to one or more data storage means, such as databases, capable of storing data related to system access, hiring policies, candidates, and screening results.

Instant data server 60 comprises one or more computing devices capable of receiving requests from service server 58 and automatically providing results to service server 58 in response to a request from service server 58. Instant data sever 60 is also capable of retrieving results from one or more databases (not shown) made a part of or connected to instant data server 60. Non-instant data server 62 comprises of one or more computing devices or terminal devices capable of receiving requests from service server 58 and sending data collected by intermediary 66 from remote data system 64 and/or remote data source 68 to service server 58. Remote data system 64 may comprise a computing device having one or more databases (not shown) as a part thereof or connected thereto. Remote data source 68 may comprise a non-computing device having access to one or more database, electronic files, and/or files of printed materials searchable by intermediary 66 according to data sent to non-instant data server 62 from service server 58. For example, remote data source 68 may comprise paper court files, printed results from a court system that is not linked to or available to service server 58, or a CD provided by a court in response to the request for information.

Both instant data server 60 and non-instant data server 62 are in bidirectional communication with service server 58 so as to also receive data from service server 58 and to communicate results to service server 58. While the embodiment of FIG. 1 shows service server 58 connected to instant data server 60 and non-instant data server 62 via network 70, it is contemplated to be within the scope of the invention for service server 58 to be directly connected or connected through another network or series of networks to instant data server 60 and/or to non-instant data server 62.

As previously stated, service server 58, instant data server 60, non-instant data server 62, remote data system 64, and, optionally, remote data source 68 comprise computing devices. Examples of computing devices include computers, servers, other processors, or any combination thereof. Non-instant data server 62 is required to have a mechanism to present to intermediary a request from service server 58, and, if the results are provided in electronic form to non-instant server 62, to present such results to intermediary 66 input mechanisms include keyboards, voice recognition, or other input mechanisms well known in the art. Presentation mechanism include a display, printer, speaker, or other presentation mechanisms well known in the art.

Intermediary 66 is representative of human intervention—one or more manual operations by one or more persons. Intermediary 66 is necessary to retrieve data from remote data source 68.

It will be appreciated by those of skill in the art that the system of FIG. 1 is illustrative of a system known as an application service provider system—one in which the software is made available to users on a service provider's server (in this embodiment, service server 58). It is contemplated to be within the scope of the invention for user systems to be computing devices having software thereon of the type loaded on the service provider's server for the purpose of entering and retrieving from instant and non-instant servers screening information for candidates. In this environment, the user system will need to have access to instant data source 60 and non-instant data source 62, such as by one or more networks.

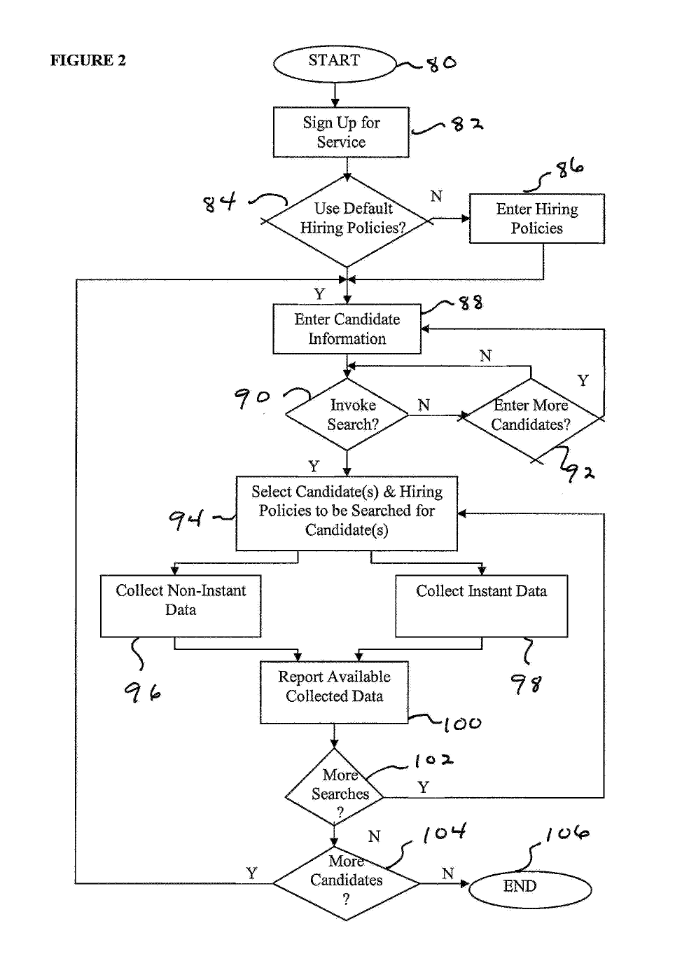

FIG. 2 shows a flow chart of one embodiment of the method of screening candidates according to the present application. In this embodiment, the process starts a step 80 when a user (an authorized user of an employer) accesses service server 58 over network 70 via one of first, second, or third user systems 52, 54, or 56, respectively. For purposes of example, we will assume that the user is using first user system 52. If this is the first time a user from the employer is accessing the screening system, the user signs up for the screening service at step 82.

At step 84, the user is given the choice to use default hiring policies mad available on service server 58 for screening one or more candidates, or to enter hiring policies specific to the employer at step 86. At step 88, the user enters candidate information on first user system 52. Candidate information entered may include basic information, such as name, social security number, gender, and the like, as well as addresses (present and former) and other information needed for the purpose of identifying the candidate at either instant data source 60, remote data system 64, or remote data source 68.

At step 90, the user is given the option by service server 58 to invoke a screening search for the candidate(s) for whom data has been entered. If the user does not wish to invoke a search, the user proceeds to enter more candidate information on first user system 52 at step 92. If the user opts to invoke the screening search at step 90, then at step 94, the user selects, using first user system 52, the candidate(s) and the respective hiring policies to be used for each candidate for the desired screening search.

Once the user selects one or more candidates and the applicable hiring policy for each candidate, at step 94, service server 58 communicates with non-instant data server 62 at step 96 and/or with instant data server 60 at step 98 to collect the requested screening information for the selected candidate(s). Instant data server 60 is representative of one or more such servers each having access to one or more databases having information of the type requested by the user for the hiring policy(ies) for the selected candidate(s) residing thereon, and thus readily available to be sent by instant data server 60 back to service server 58. The term “instant” is meant to refer to automatic data retrieval, as compared to “non-instant” data retrieval in which, as further described herein, the data retrieval process requires one or more instances of human intervention, i.e., one or more manual operations. Further, it is not necessarily the case that data from instant data server 60 will “instantly” be sent back to service server 58—there may be delay in sending such data from instant data server to service server 58.

As previously mentioned, retrieval of data in response to the screening request in step 96 is through non-instant data server 62 and/or instant data server 60. The data required for the screening search through non-instant data server 62 is of the type that requires human intervention. Manual operations are required by intermediary 66 to retrieve the data from remote data source 68 and make that retrieved data available to non-instant data server 62. For example, if criminal conviction information is a party of the selected hiring policy, but not all such information is made available on a remote data system 64, intermediary 66 retrieves the criminal conviction information for the candidate(s) from remote data source 68 (such as a paper filing system at a court, for example), and then enters the retrieved information on non-instant data server 62 for communication to service server 58.

When screening results are obtained through step 96 and/or step 98, those results are made available to service server 58 as described herein. Some hiring policies may require collection of “instant” data, “non-instant” data, or any combination thereof. At step 100, collected data is made available in report form to the user. It is worthy to note that not all requested data for a particular hiring policy may be available to service server 58 at the same time. It is likely that results provided from non-instant data server 62 through step 98 will be available at a later time than data from instant data server 60 through step 96. Also, more than one instant data server 60 and/or more than one remote data system 64 may be used so that not all “instant” data is provided to service server 58 at the same time. Further, more than one non-instant data server 62 and/or more than one remote data source 68 may be used so that not all “non-instant” data is provided to service server 58 at the same time. However, as results are made available to service server 58, the user may access the results through the user's connection of first user system 52 to service server 58 at step 100.

At step 102, the user is given the opportunity to perform additional screening searches. If more searches are requested for entered candidates, the method proceeds to step 94 for the selection of candidate(s) and hiring policies. If no more searches are required for the entered candidates, the user is given the opportunity at step 104 to indicate whether additional candidates are to be entered. If more candidates are to be entered, the method proceeds to step 88 for entry of additional candidate information If no more candidates are to be entered, the process of screening searches for this session for the user ends at step 106.

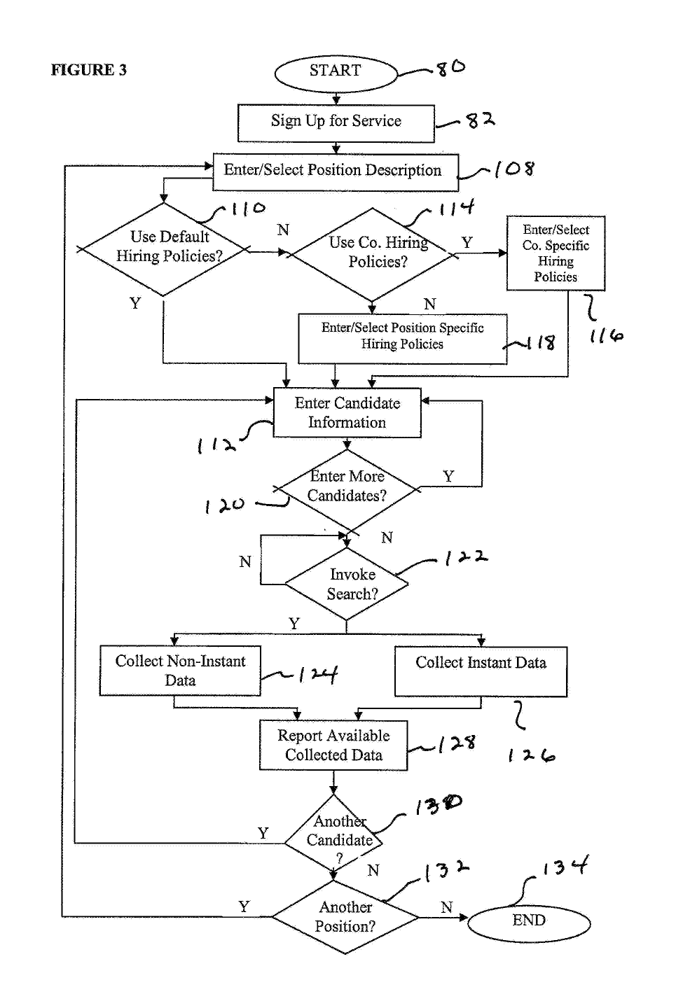

Referring now to FIG. 3, there is shown another embodiment of the method of screening candidates according to the present application. In this embodiment, the user is able to use default hiring policies, and to establish hiring policies based on the employer and/or based on the specific position. The method of FIG. 3 begins at step 80 wherein the user logs onto to service server 58 via one of first, second, or third user systems 52, 54, or 56, respectively. If the employer had not yet signed up to receive the screening service, the user signs the employer up for the service at step 82.

At step 108, the user enters or selects a position description/package name for which one ore more screening searches are to be performed for one or more candidates. At step 110, the user is asked whether to use the default hiring policies for that position/package. If default hiring policies are to be used, the system proceeds to step 112 for entry of candidate information for that position. If default hiring policies are not to be used for this position, the user is asked in step 114 whether to use the employer's general hiring policy (such a policy is not dependent upon position). If the employer's general policy is to be used, the employer's general policy is selected (if it already had been entered, such as in a previous session) or entered (if it does not already exist) in step 116, and the system proceeds to step 112 for entry of candidate information for the specified position. If the employer's general policy is not to be used for the specified position, the user selects the position-dependent hiring policy (if it already had been entered, such as in a previous session) or enters the position-dependent hiring policy (if it does not already exist) in step 118, before proceeding to step 112 for entry of candidate information for the specified position.

Entry of a policy, such as an employer specific policy or a position-dependent policy, is achieved by entry of a decision matrix. The decision matrix identifies the characteristics to be evaluated as well as the ratings associated with the characteristics, and/or general ratings. The decision matrix is discussed in greater detail later herein.

At step 112, the user enters candidate information using first user system 52. The user is given the option, at step 120, to enter information for additional candidates. Once all information for candidate(s) for the position has been entered in steps 112 and 120, the user make invoke a screening search for the selected candidate(s) using the selected hiring policy(ies) at step 122. Once a screening search is invoked at the user's election at step 122, the system proceeds to collect non-instant data at step 124 and to collection instant data at step 126. As such collected data is available, the user is able to view a report of the collected data at step 118.

The user may opt to enter additional candidate information at step 130. If additional candidate information is desired to be entered, the process returns to step 112. If the user does not wish to enter additional candidate information, the user can opt, at step 132, to enter information for another position. If the user desires to enter information for another position, the process proceeds to step 108. If the user does not desire to enter information for another positions, in this embodiment, the process ends at step 134.

As with the embodiment of FIG. 1, the collection of non-instant data in step 124 and the collection of instant data 126 in step 126 do no necessarily occur simultaneously, nor are the results from such collection necessarily received at the same time. Thus, at step 128, the user will able to discern which results have been collected, and can return to step 128 to see if additional results have been collected.

It will be appreciated by those of skill in the art that the software residing on service server 58 can also provide the user with the opportunity to edit, delete, copy, and move previously entered data as is well known in the art. It will also be appreciated that variations of the processes beyond the two embodiments described in association with FIG. 2 and FIG. 3 are possible, and are contemplated to be within the scope of the invention. The system of the present application may perform various steps in a serial and/or parallel manner and still obtain the screening results desired.

A predetermined policy for hiring, retention, promotion, and the like can include several different characteristics to be searched for any particular candidate. In one embodiment, a hiring policy includes eleven predefined characteristics, namely:
1. Job fit assessment
2. Bankruptcy risk
3. Credit worthiness
4. Criminal risk
5. Civil risk
6. Social Security Number (“SSN”) verification
7. Driver safety
8. Reference verification
9. Sexual harassment risk
10. Workers' compensation risk
11. Terrorist alert

As illustrated in FIG. 2 and FIG. 3, an employer may define one or more decision matrices for rating purposes. A decision matrix is generally a collection or grouping of characteristics, but is not required to comprise more than one characteristic. An employer may use the service provider established decision matrix, may establish one or more employer-specific matrices, and/or may establish one or more position/package-dependent matrices. According to one embodiment of the system, the employer can build its matrices via a self-service wizard made available on service server 58. It is also possible for multiple matrices to be in effect at the same time, and more than one type of decision matrix can be in effect at the same time. For example, the employer may establish an employer-specific matrix, a management decision matrix, a driver decision matrix, and a salesperson decision matrix. Any matrix, whether provided by the service provider or defined by the employer, may be applied to any candidate. In one embodiment, different orders may be placed for screening a candidate, with each order specifying a particular decisions matrix to be utilized. In another embodiment, a single order may allow the use of more than one decision matrix in the screening for a candidate. In yet another embodiment, line items (as discussed later herein) across orders may be aggregated across orders for ratings thereof.

In one embodiment, each characteristic of a decision matrix is identified has having a characteristic type of either configurable, non-configurable, or pseudo-configurable. A configurable type is one for which a user may define the criteria to be evaluated and map the results to one or more ratings (acceptable, not acceptable, etc.). A non-configurable type is one for which the service provider defines the criteria and maps the results to one or more ratings, and the user is not permitted to define the criteria or map the results. A pseudo-configurable type is one for which the service provider defines the criteria and the user maps the results to one or more ratings. Thus, ratings of the decision matrix are associated with a characteristic.

Each characteristic may comprise more than one category, and each category may comprise more than one subcategory. For example, when considering the a Criminal Risk characteristic, categories of criminal risk may include, immoral/sexual, controlled dangerous substances, abuse/endangerment, theft/dishonesty, violence/harassment, traffic, weapons, mischief/trespass, court order violations, conspiracy, ignore, for example, Subcategories of the theft/dishonesty risk category may include fraud, bad checks, theft, and dishonesty, for example. Each and every, and collectively, the subcategories, categories, and characteristics may have one or more ratings associated therewith, and values established therefor in a decision matrix and can be rated according to the system and method of the present application. Thus, in stating that ratings are associated with a characteristic, this also means that the ratings are associated by categories or subcategories of the characteristic.

For rating purposes, the service provider may make available pre-defined variables to be searched and the values or ranges for each subcategory, category, and/or characteristic. The service provider may also make qualifications for such ratings available to summarize the results of a screening search based on a decision matrix. Such qualifications may include, for example:
Meets Policy
Meets Policy with Alert
Indeterminate
Indeterminate with Alert
Does Not Meet Policy
Does Not Meet Policy with Alert
   The “Alert” referred to in this example is likely to present alerts made available by the service provider. Such alerts may comprise an e-mail to the employer, a flashing indicator, sounds (such as beeps), icons or other common alerts known in the art.

Table 1 attached hereto as Appendix A lists information about characteristics included in the service provider's default screening policy (decision matrix) according to one embodiment of the present application. According to this embodiment, the system includes non-configurable, configurable, and pseudo-configurable (semi-configurable) characteristics for inclusion in a default decision matrix, employer-specific decision matrix, or position-specific decision matrix. Table 1 also illustrates that the data sources for a characteristic may be instant, non-instant, or a combination thereof. For example, results for SSN Validation can be acquired from an instant data source, such as the proprietary database of ADP, Inc. made available via updates from the Social Security Administration, as well as the Death Master Database provided by the U.S. Department of Commerce; results for Reference Verification is acquired from a non-instant data source, such as the search of employment, volunteer, educational, and database records, as well as data provided via a reference's contact's memory, by intermediary 66, as well as database services available by phone; and results for Criminal Risk can be acquired from an instant data source, such as the CrimLink multijurisdictional database made available from National Background Data, as well as online websites that offer instant data, and by checking of court house records by intermediary 66.

As shown in Table 1, the non-configurable characteristics, those universally applied to all decision matrices for employers, for this embodiment are Bankruptcy Risk, Civil Risk, Sexual Harassment Risk, Terrorist Alert, Workers' Compensation Risk, Criminal Risk (for Colorado, statewide, only), and Job Fit Assessment. Search results mapped to results for these non-configurable characteristics may be, for example:

| | | |
|---|---|---|
| Examples: | RECORD | = DOES NOT MEET POLICY |
| | NO RECORD | = MEETS POLICY |
| | UNKNOWN | = INDETERMINATE |

*Note: Generally, separate sets of mappings will be applied to each non-configurable characteristic, as results for any particular characteristic are data driven and thus not pre-set, the results provided for a characteristic and can change over time

The semi-configurable characteristic of this illustrative decision matrix Reference Verification. As semi-configurable, the employer is able to map the search results to one or more ratings in a manner to fit the employer's specific needs, i e., the employer's own policy(ies) or those required by applicable law. For the Reference Check characteristic, the service provider's services, by access to one or more data sources, will yield six search results values, and all six search results values can be used in rating the Reference Check characteristic. The following is an example of a mapping of results to ratings for Reference Verification:

| | | |
|---|---|---|
| Example(RC): | VERIFIED | = MEETS POLICY |
| | INFO DIFFERENCE | = INDETERMINATE |
| | DEROGATORY | = DOES NOT MEET |
| | | POLICY |
| | NO LISTING | = INDETERMINATE |
| | REQUEST CANCELLED | = INDETERMINATE |
| | UNABLE TO VERIFY | = INDETERMINATE |

Continuing with this embodiment of the decision matrix, certain characteristics are configurable. The configurable characteristics, those for which the employer is able define both the rating criteria and the ratings for these characteristics, are SSN Verification, Credit Worthiness, Criminal Risk, and Driver Safety. According to this embodiment, SSN Verification may be rated based on the following criteria:
a) Invalid SSN
b) SSN in the Death Master
c) SSN issued prior to date of birth (“DOB”) (If this rule is selected, but no candidate DOB is available, the engine will automatically issue a rating of INDETERMINATE, with an alert of NO DOB PROVIDED)

The following is an example of a possible employer-defined SSN Verification rating scheme:
DOES NOT MEET POLICY if SSN is INVALID or
DOES NOT MEET POLICY if SSN is in the Death Master or
INDETERMINATE if SSN was issued prior to the applicant DOB

The Credit Worthiness characteristic can be rated on the following criteria:
a) Public Records
   1) A quantity threshold for public records can be specified
b) Collection Records
   1) A quantity threshold for collection records can be specified
   2) The number of years to search back can be specified for interrogating collection date on applicant reports
c) Public Records and Collection Records
   1) A quantity threshold from either Public Records or Collection Records can be specified
d) Number of accounts currently in Negative status
   1) A quantity threshold for current negative accounts can be specified
e) Number of accounts previously in Negative status
   1) A quantity threshold for previous negative accounts can be specified
f) Past Due Amount
   a. A dollar amount threshold for Past Due Amounts can be specified

The following is an example of a possible employer-defined Credit Worthiness rating scheme:
DOES NOT MEET POLICY if 3 or more Public Records or
DOES NOT MEET POLICY if 3 or more Collections in last 2 years or
DOES NOT MEET POLICY if 3 or more Public or Collection Records or
INDETERMINATE if 2 or more Current Negative Accounts or
INDETERMINATE if Past Due Amount greater than $10,000

Other, miscellaneous credit issues are also made available to the employer for inclusion in a decision matrix. These credit issues include:
a) Tenant Credit reports will not be rated as of this time
b) Hawk Alerts found on credit reports will trigger as service provider defined notification alert
c) If a duplicate record exist on the credit reports (from the credit companies), the service provider will de-duplicate the records

Criminal Risk can be rated, in this embodiment, on the following criteria:
a) Criminal Category—all offenses will be grouped into the following categories for rating purposes:
   1. IMMORAL/SEXUAL
   2. CONTROLLED DANGEROUS SUBSTANCES
   3. ABUSE/ENDANGERMENT
   4. THEFT/DISHONESTY
   5. VIOLENCE/HARASSMENT
   6. TRAFFIC
   7. WEAPONS
   8. MISCHIEF/TRESPASS
   9. COURT ORDER VIOLATIONS
   10. CONSPIRACY
   11. IGNORE
b) Criminal Sub-Category—all offenses will be group into Sub-Categories (the following is an example of the sub-categories in the Theft category:)
   1. FRAUD
   2. BAD CHECKS
   3. THEFT
   4. DISHONESTY
c) Years Back—how far back should offenses be looked at
d) Count Threshold (i.e.: 3 or more Theft felonies)
e) Disposition—all offenses will be categorized with the following Dispositions:
   1. ARREST/COMPLAINT
   2. DEFERRAL
   3. CONVICTION
   4. NON-CONVICTION
   5. IMMEDIATE DISMISSAL
   6. UNCLASSIFIABLE
f) Level—all offenses will be categorized with the following Levels:
   1. FELONY
   2. MISDEMEANOR
   3. TRAFFIC
   4. ORDINANCE
   5. UNKNOWN OFFENSE LEVEL

The following is an example of a possible employer-defined Criminal Risk rating scheme:
DOES NOT MEET POLICY if
   1 or more Felony THEFT-Fraud Convictions in the last 3 years or
   1 or more Felony THEFT-Dishonesty Convictions in the last 3 years or
   1 or more Felony VIOLENCE/HARASSMENT-*(of any kind) in last 2 yrs or
   2 or more Felonies Convictions of any kind in the last 3 years or
INDETERMINATE if
   1 or more Felony MISCHIEF/TRESPASS Convictions in the last 5 years or
   3 or more Misdemeanors Convictions of any kind in the last 5 years

Other, miscellaneous criminal issues are also made available to the employer for inclusion in a decision matrix. These criminal issues include:
a) Employers will have the capability to have their rules evaluated cross multiple line items. For example, if an employer's rule specified two (2) or more felonies, and a candidate had one (1) felony in Colorado, and one (1) in Kansas, the rule would only evaluate to TRUE if the employer chooses to evaluated it across multiple line items.
b) If a single offense falls into more that one category (for example, Possession of a weapon while intoxicated could fall in to the Controlled Substance category and the Weapons category) the offense would be counted twice in terms of rule evaluation unless the same rule is not triggered.
c) All criminal records returned to the service provider, including any that may be juvenile records, will be used in the rating (i.e., if the employer orders reports that overlap, the service provider will use all information returned, even if it is duplicated—the service provider will assume the employer is responsible for what they order
d) The criminal charge used in the decision matrix will be the final charge, whether this is the same as the initial arrest charge or differs. This means that the service provider, when evaluating search results, will look for the charge in the Disposition field first. If no charge is found here, then the charge in the Offense field will be used.)
e) According to this embodiment, due to restrictions associated with available search results, the Criminal Risk characteristic for Colorado, statewide, is non-configurable. If there are changes in the data source(s) for such Colorado criminal risk data, the Criminal Risk characteristic could be redefined as configurable.
f) Wants and Warrants will not be rated.

According to this embodiment of the present application, Driver Safety can be rated on the following criteria:
a) ACD Headers—all violations are grouped into the following categories for rating purposes:
   1. ALCOHOL AND DRUG (CONTROLLED SUBSTANCES) VIOLATIONS
   2. DUTIES FAILED—REQUIREMENTS NOT MET—IMPROPER BEHAVIOR
   3. EQUIPMENT/VEHICLES—REGULATIONS, DEFECTS, AND MISUSE
   4. MANEUVERS—ILLEGAL OR IMPROPER
   5. SPEEDING
   6. UNCLASSIFIED OFFENSES
   7. WITHDRAWALS
   8. SUSPENSION/REVOCATION/WITHDRAWAL/ETC.
   9. AT-FAULT ACCIDENTS
   10. VIOLATIONS TO BE IGNORED
b) ACD Group—all violation are grouped into the following ACD Groups (the following is an example of the ALCOHOL AND DRUG header):
   1. DRIVING UNDER THE INFLUENCE OVER SPECIFIED BAC LEVELS
   2. GENERAL DRIVING UNDER THE INFLUENCE (DUI GROUP)
   3. POSSESSION OFFENSES (POS GROUP)
   4. IGNITION INTERLOCK DEVICES (IID GROUP)
   5. TRANSPORTING A CONTROLLED SUBSTANCE (TCS GROUP)
   6. UNDERAGE DRINKING GROUP
   7 ADMINISTRATIVE PER SE
c) Invalid License
d) Count threshold (i.e.: 3 or more Speeding)
e) Number of years back (the violation occurred)

According to this discussed embodiment, the following comprise available search data sources that are not rated, i.e., are not included in a ratable characteristic:
a) All data sources in the NameLink product group (except for CrimLink) made available by credit bureaus and related to credit header data
b) Employment Applications
c) Instant Address Link made available by Accurint and related to credit header data
d) Adverse Action
e) Drug Tests
f) Wants and Warrants
g) Tenant/Consumer Credit Link made available by Transunion and related to credit data
h) International Criminal Histories

However, it is possible for the service provider to make available characteristics that utilize these data sources as well as other data sources that may be of value to employers. Other characteristics beyond those discussed herein that may included in the decision matrix and are contemplated to be within the scope of the invention include retail theft, drug testing, international criminal histories, and identity.

This embodiment describing various non-configurable, configurable, and semi-configurable characteristics is illustrative, and is not intended to be limiting in any respect, As discussed herein with regard to FIG. 2 and FIG. 3, the system is configured to retrieve relevant results relating to qualifications of a candidate from either instant or non-instant data sources. To the extent that additional or new data sources are made available, additional or modified characteristics (and categories and subcategories thereof) may be searched and characteristics may be defined as non-configurable, configurable, or semi-configurable based on the one or more data sources applicable to that characteristic.

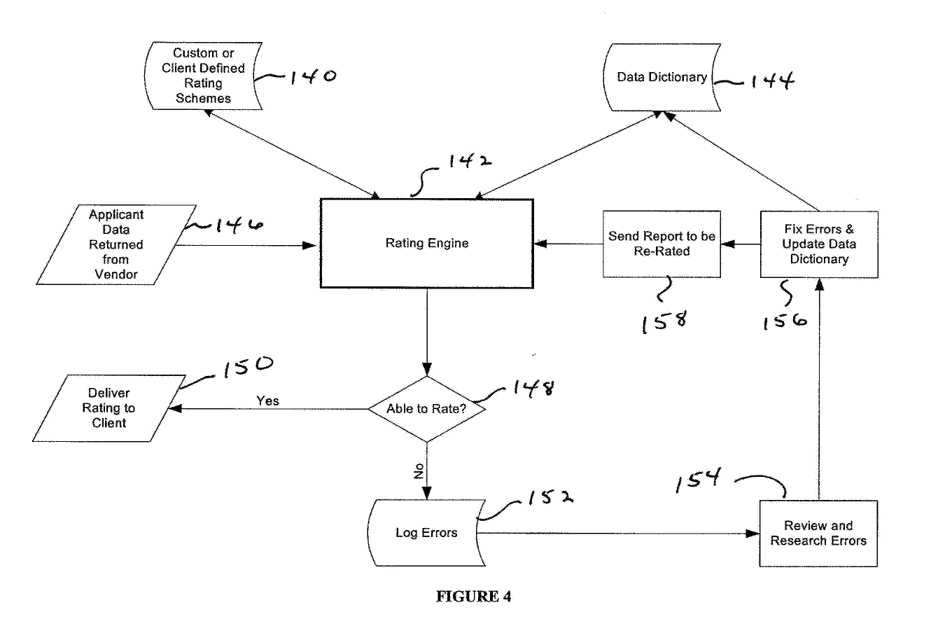

Referring now to FIG. 4, there is shown schematic diagram of one embodiment of the process of rating, correcting ratings, monitoring errors with the rating engine according to the present application. As described herein, the employer is able to define its own decision matrices. By providing the employer with such flexibility, there is a possibility that errors can occur. Such errors may occur in the selection of criteria and/or ratings by the employer or in a change in the data made available from a data source, for example. As shown in FIG. 4, rating schemes 140 accessible to service server 58 (see FIG. 1) are communicated to rating engine 142 residing on service server 58. Data dictionary 144, also accessible to service server 58, is also in communication with rating engine 142. Rating engine 142 compares rating scheme 140 to data dictionary 144 to make certain that rating scheme 140 is using recognized ratings. Candidate data 146 collected from a data source is communicated to rating engine 142. Rating engine 142 determines at step 148 whether rating engine 142 is able to rate candidate data 146 based on rating schemes 140. If rating engine 142 is able to rate candidate data 146 based on rating schemes 140, the ratings are delivered to the employer at step 150.

If rating engine 142 is not able to rate candidate data 146 based on rating schemes 140, the system proceeds to step 152 where the error(s) is(are) logged. At step 154, the logged errors are reviewed and researched by one or more persons to determine the cause of the error and to ascertain how to correct the error. The error is corrected and data dictionary 144 is updated by one or more persons, if appropriate, in step 156. After the error is corrected, candidate data 144 and rating scheme 140 are resent to rating engine 142.

It will be appreciated that steps 154 and 156 practically necessitate human intervention. Consider, for example, the possibility that an error is created because the data source has eliminated a field or reordered the fields of data provided. Identification and correction of the error would be difficult to perform automatically.

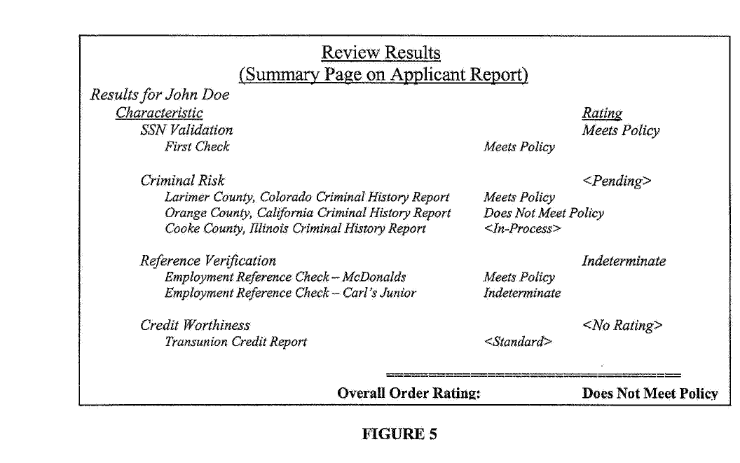

FIG. 5 shows one embodiment of a sample report resulting from the system for screening candidates according to the present application. In this report, the selected characteristics to be evaluated for candidate “John Doe” are SSN Validation, Criminal Risk, Reference Verification, and Credit Worthiness. This sample report illustrates the relation between data provided for the candidate and the characteristics. For example, candidate John Doe's data indicated that he formerly worked at McDonalds and at Carl's Junior. Thus, two Reference Verifications were required—one for each former employer. In this embodiment, individual Reference Verification ratings were made with regard to each former employer (“Meets Policy” for McDonalds, and “Indeterminate” for Carl's Junior), and one rating that is the culmination of the Reference Verification ratings for both former employers (“Indeterminate”). The rules for establishing the culmination of ratings for a characteristic may be established by the service provider or by the employer.

According to one embodiment of the present application, the hierarchical rating levels include Line Item Rating, Characteristic Rating, Overall Order Rating, and Overall Cross-Order Rating. A Line Item Rating is a rating for each line item for a characteristic assigned based on the decision matrix. A Characteristic Rating is a rating for a characteristic based on the decision matrix. A Characteristic Rating will be the summation/culmination of Line Item Ratings if more than one line item exists for a Characteristic An Overall Order Rating is the summation/culmination of the Characteristic Ratings for an Order. An Order is a request for a search for one or more characteristics for a candidate. An Overall Order Rating is provided for all characteristics on the order, regardless of whether there is overlap of data coverage. If a user wishes to exclude one of the reports in the Overall Order Rating, then he/she may request a candidate rating through a new order. An Overall Cross-Order Rating is the summation/communication for all orders for a candidate. When requesting candidate ratings across multiple orders, the user must specify which orders to include in the Overall Cross-Order Rating. If any of the orders overlap in data coverage, the Overall Cross-Order Rating will not detect the overlap. For example, if the employer ordered both a standard and an extended criminal history for the same county within the last ninety (90) days, and the user selects to include both these orders in the Overall Cross-Order Rating, then the Overall Cross-Order Rating will effected by a double rating for common results including in both the standard criminal history and the extended criminal history.

In the example of FIG. 5, the “Meets Policy” rating for McDonalds line item and the “Indeterminate” rating for Carl's Junior line item for the Reference Verification characteristic are line item ratings. The “Indeterminate” rating resulting from the culmination of the two Reference Verification line item ratings of “Meets Policy” for McDonalds and “Indeterminate” for Carl's Junior is a characteristic rating for the Reference Verification characteristic. The “Overall Order Rating” of “Does Not Meet Policy” is an overall order rating calculated from the characteristic ratings for each of the SSN Validation, Criminal Risk, Reference Verification, and Credit Worthiness characteristics. The Overall Order Rating could also be determined as an overall order rating calculated from the line item ratings (every line item for every characteristic. Because the example of FIG. 5 is only for one order for the candidate John Doe, there is no Overall Cross-Order Rating provided. As discussed above in association with the establishment of ratings for a decision matrix, the employer may specify the manner in which the characteristic ratings, overall order rating, and cross-order rating are determined by the system.

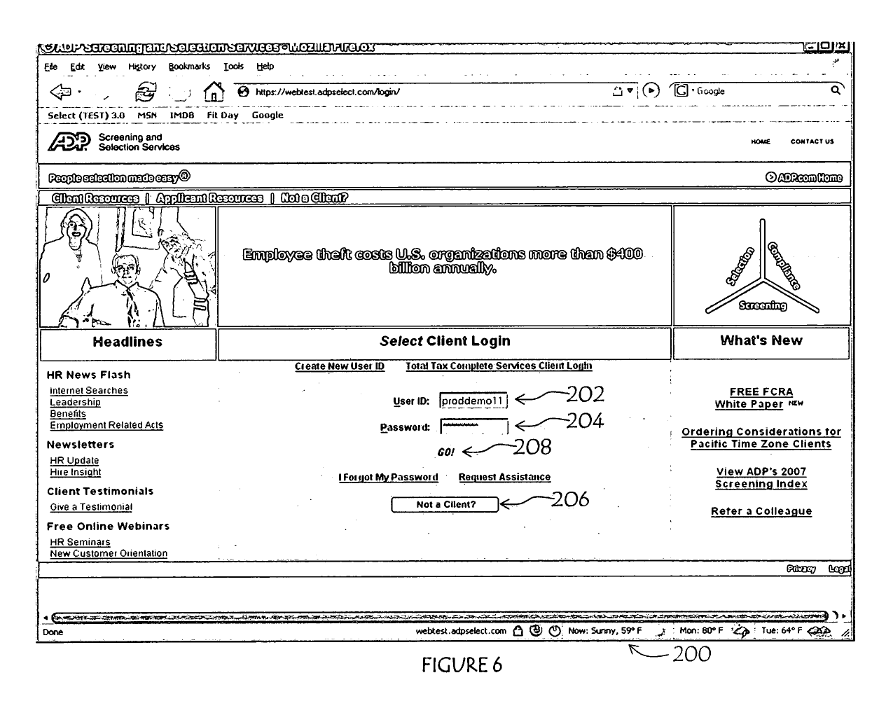

Referring now to FIG. 6 there is shown a screen shot of one embodiment of a log-on screen according to the present application. The screen shots of FIGS. 6 though 19 may displayed at one of first, second, or third user systems 52, 54, or 56, respectively. For purposes of illustration, we will consider display of these screen shots at first user system 52. Log-on screen 200 is displayed at first user system 52 upon connection of first user system to service server 58 via network 70 in a manner well known in the art. To associate log-on screen 200 with the methods presented in FIG. 2 and FIG. 3, log-on screen 200 is of the type displayed at start step 80.

Presented on log-on screen 200 are User ID box 202, Password box 204, “Not a Client?” button 206, and Go button 208. If the user of the employer having access to first user system 52 has an existing user id and password for access to service server 58, the user enters its user id in User ID box 202, enters its password in Password box 204, and selects Go button 208. If, on the other hand, the user does not have a user id and password, the user selects, by mechanisms well known in the art of graphical user interface systems, the “Not a Client?” box 206 . Selection of the “Not a Client?” box 206 will result in display of one or more screen shots to allow the employer to sign up for access to service server 58, or to provide information to the employer for signing up for access to service server 58. As part of the process of the employer signing up for access to service server 58, the employer will be provided with one or more sets of user ids and passwords for the employer's users.

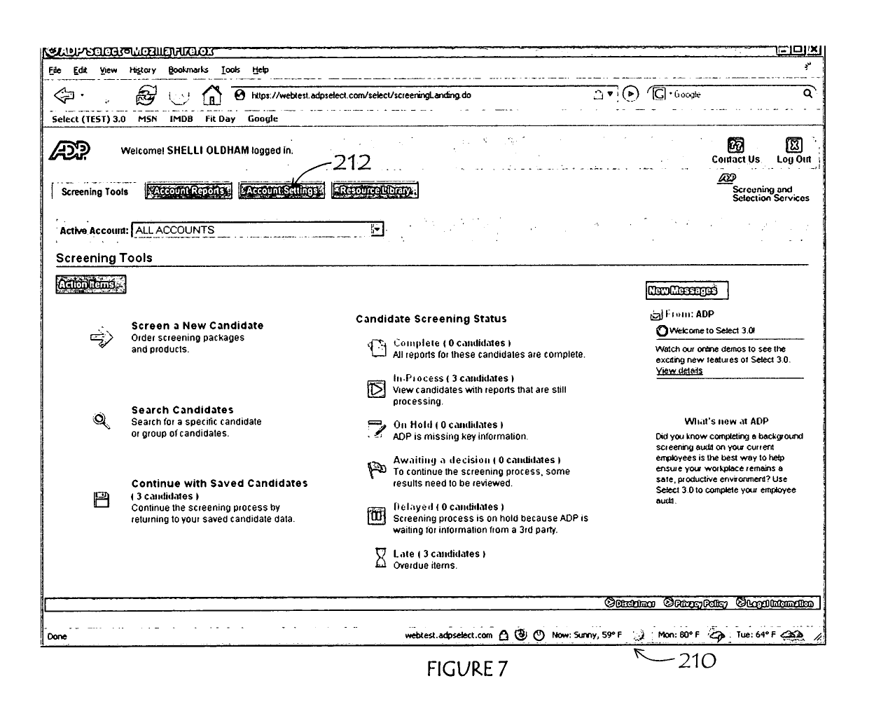

FIG. 7 shows a screen shot of one embodiment of a screening tools screen according to the present application. Screening tools screen 210 is displayed in response to selection of Go button 208 in FIG. 6, assuming that the user entered a valid user id and password on log-on screen 200. To sign up for the screening service (akin to step 82 of FIG. 2 and step 82 of FIG. 3), the user selects Account Settings button 212 on screening tools screen 210.

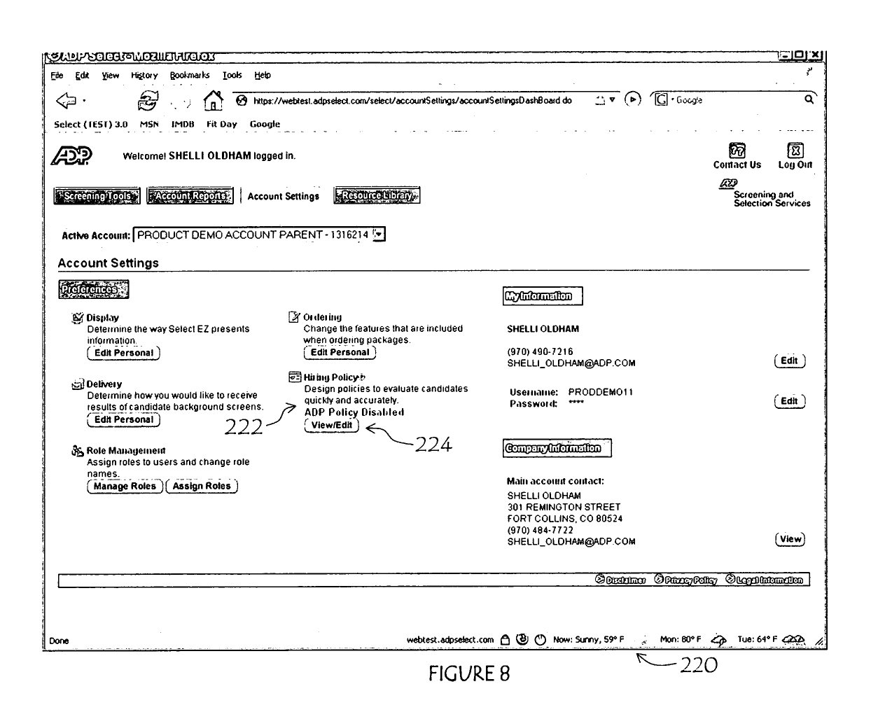

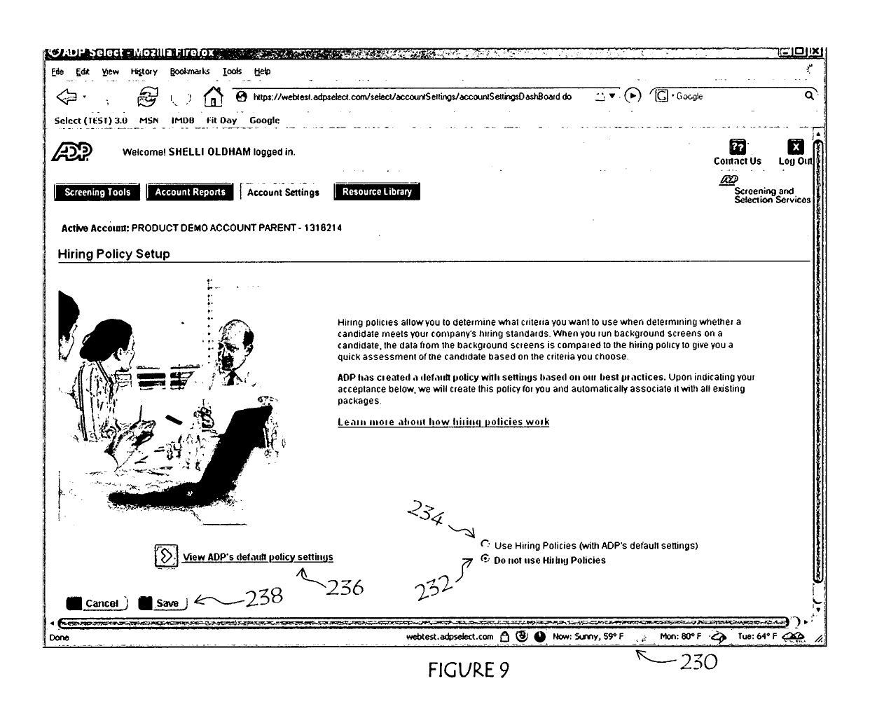

Referring now to FIG. 8 there is shown a screen shot of one embodiment of an account settings screen according to the present application. Account settings screen 220 is displayed upon selection of Account Settings button 212 on screening tools screen 210 of FIG. 7. Shown on accounting settings screen 220 is Hiring Policy text 222 followed by View/Edit button 224. Included in the embodiment of FIG. 8 in Hiring Policy text 222 is the language “ADP Policy Disabled”. The “ADP Policy Disabled” language of Hiring Policy text 222 indicates that the hiring policy has not yet been enabled. To enable the hiring policy, the user selects View/Edit button 224.

FIG. 9 shows a screen shot of one embodiment of a hiring policy setup screen according to the present application. Upon selection of View/Edit button 224 of account settings screen 220 of FIG. 8, hiring policy setup screen 230 of FIG. 9 is displayed. If the user decides that he/she does not want to enable the hiring policies, the user selects Do not use Hiring Policies button 232. If; on the other hand, the user wishes to enable the hiring policies, the user selects Use Hiring Policies button 234. If the user wishes to see the default settings used in the hiring policies, the user may select View default policy settings box 236. To save the selection of either Use Hiring Policies button 234 or Do not use Hiring Policies button 232, the user selects Save button 238. While in the embodiment of FIG. 9, Hiring Policies button 234 implies that default settings will be used, it is contemplated to be within the scope of the invention for hiring policy setup screen 230 to have another option—the use of employer defined policies.

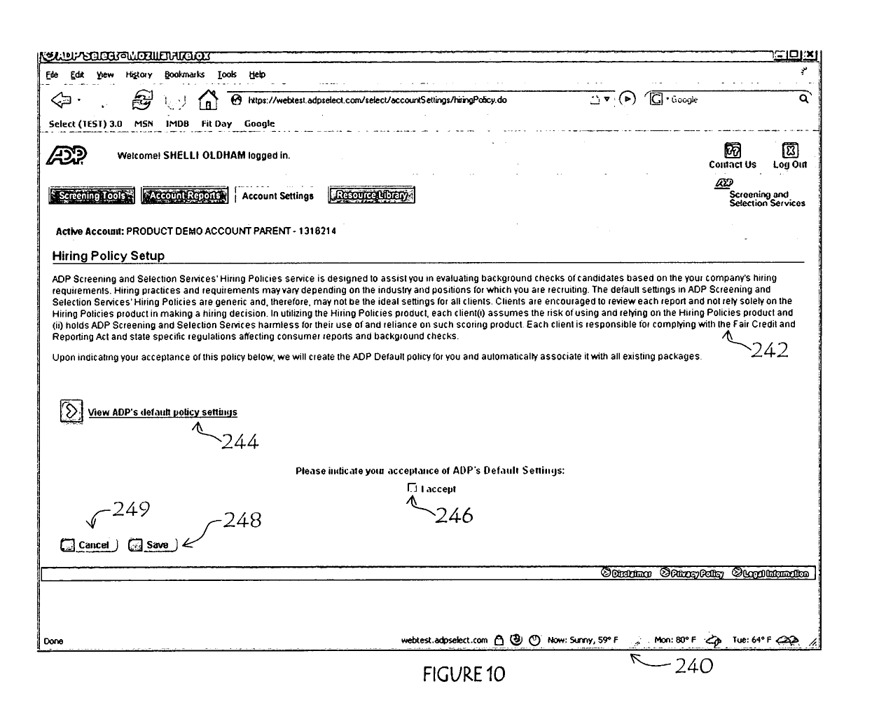

Referring now to FIG. 10 there is shown another screen shot of an embodiment of a hiring policy setup screen according to the present application. Second hiring policy setup screen 240 provides the user with information 242, and gives the user the option to view the default policies settings by selection of View default policy settings box 244. The user may accept the use of the default settings for the hiring policy by selecting I accept box 246 and Save button 248. Alternately, if the user does not accept the use of the default settings for the hiring policy or the use of the hiring policy functionality, in general, the user selects Cancel button 249.

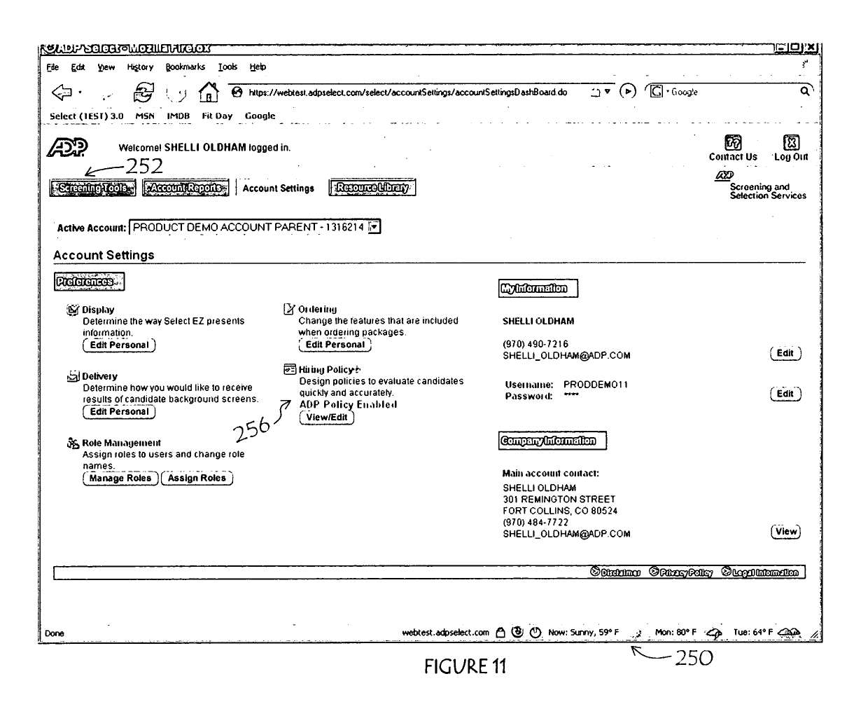

FIG. 11 shows a screen shot of the embodiment of the account settings screen of FIG. 8 wherein the hiring policy is now enabled. Account settings screen 250 of FIG. 11 is shown if the user accepts the default settings in second hiring policy setup screen 240. Account settings screen 250 differs from account settings screen 220 of FIG. 8 in that Hiring Policy text 256 of FIG. 11 now shows that the hiring policy is enabled. Upon enablement of the hiring policy, the user may proceed to use the screening tool by selecting Screening Tools box 252.

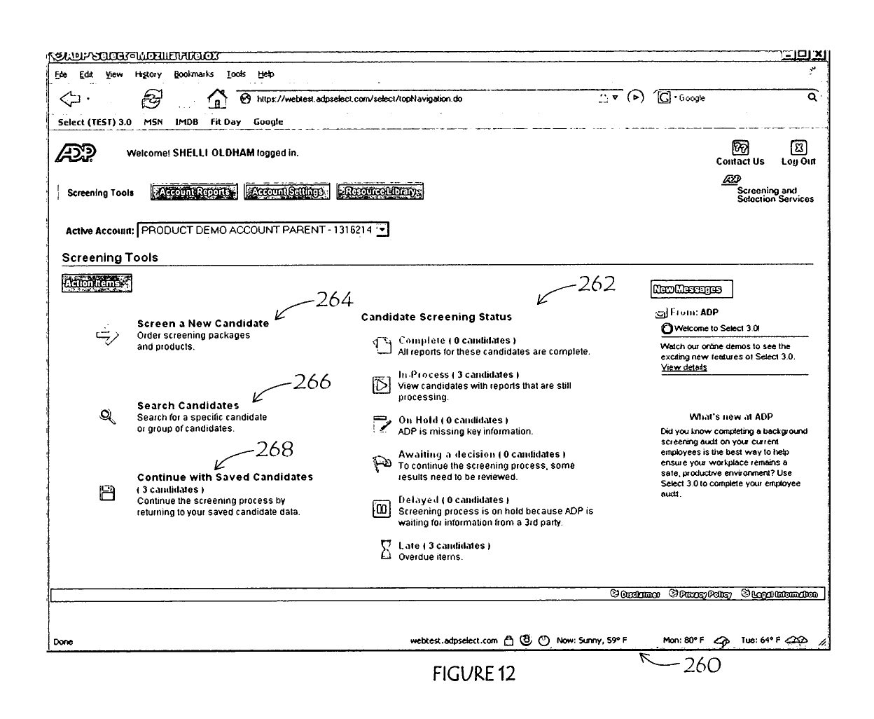

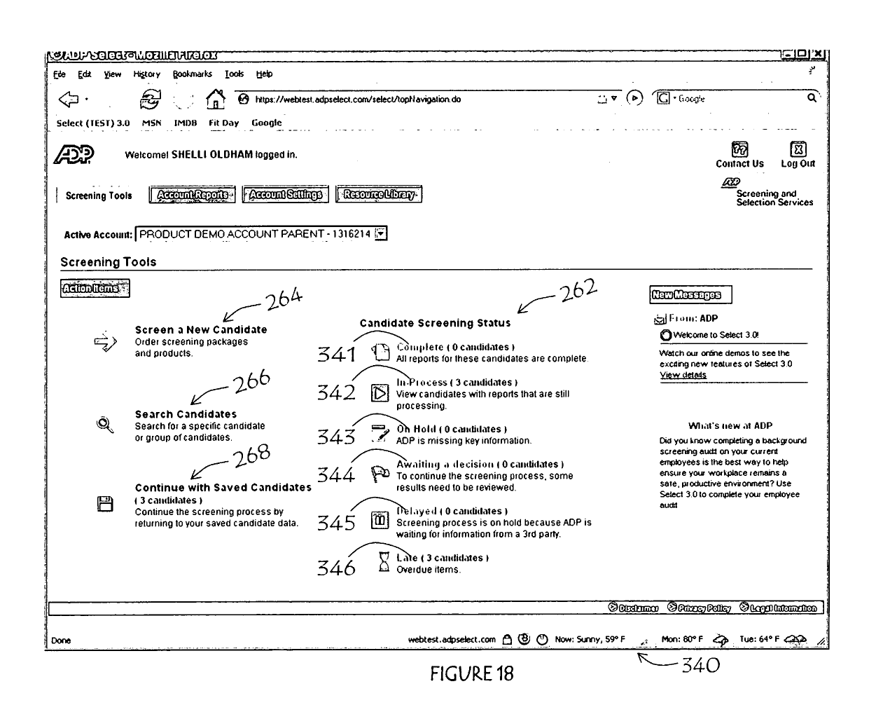

Referring now to FIG. 12 there is shown a screen shot of one embodiment of the action items screen according to the present application. Action items screen 260 of FIG. 12 is displayed in response to selection by the user of Screening Tools button 252, assuming, of course, that the hiring policy is enabled for the user. From action items screen 260, a user can perform a variety of functions related to screening of candidates. These functions include viewing the status of current searches at Candidate Screening Status text 262, screening a new candidate by selecting Screen a New Candidate action 264, searching for specific candidates or groups of candidates by selecting Search Candidates action 266, and instructing the system to continue the searching process for saved candidates by selecting Continue with Saved Candidates action 268. Candidate Screening Status text 262, Search Candidates action 266, and Continue with Save Candidates action 268 will be discussed in greater detail herein in association with FIG. 18. At this point, consider that the user desires to order screening services for a new candidate. To do so, the user selects Screen a New Candidate action 264.

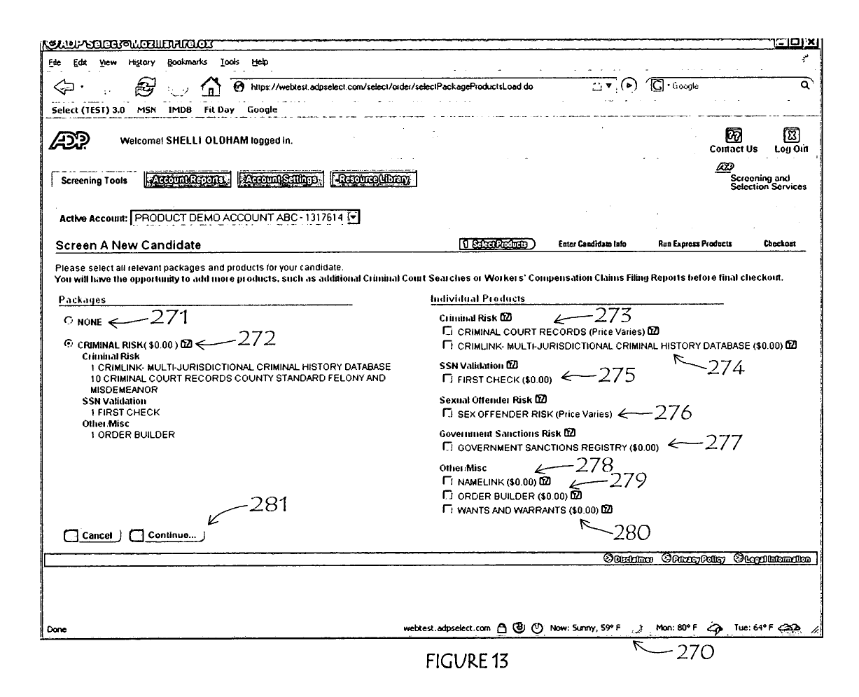

FIG. 13 shows a screen shot of one embodiment of the screen a new candidate screen according to the present application. Screen a new candidate screen 270 is displayed in response to selection of Screen a New Candidate action 264 from action items screen 260 of FIG. 12. In this embodiment, the user is provided with two options for searches—Packages for a collection of various characteristics to be searched, and Individual Products for screening based on smaller groups of characteristics or individual characteristics. On screen a new candidate screen 270, the user is presented with options of obtaining no packages by selection of None button 271; a criminal risk package containing criminal risk, SSN Validation, and other by selection of Criminal Risk button 272; criminal court records by selection of Criminal Court Records box 273, CrimLink multi-jurisdictional criminal history database by selection of CrimLink box 274; SSN validation by selecting SSN validation box 275; sexual offender risk by selecting Sexual Offender Risk box 276; government sanctions risk by selecting Government Sanctions Registry box 277; a NameLink search by selecting NameLink box 278; an order builder service by selecting Order Builder Box 279; and or a wants and warrants search by selecting Wants and Warrants box 280. In this embodiment, the order builder services takes an Instant Address Link and CrimLink data and suggests additional locations for which criminal history data should be searched for the candidate. The user may select any combination of packages and individual products made available. Once the user has made his/her selection of the types of screening searches to be performed, in this case, the selection of the criminal risk package by selection of Criminal Risk button 272, the user selects Continue button 281 to proceed to identify the candidate(s) who are to be evaluated using the selected search criteria.

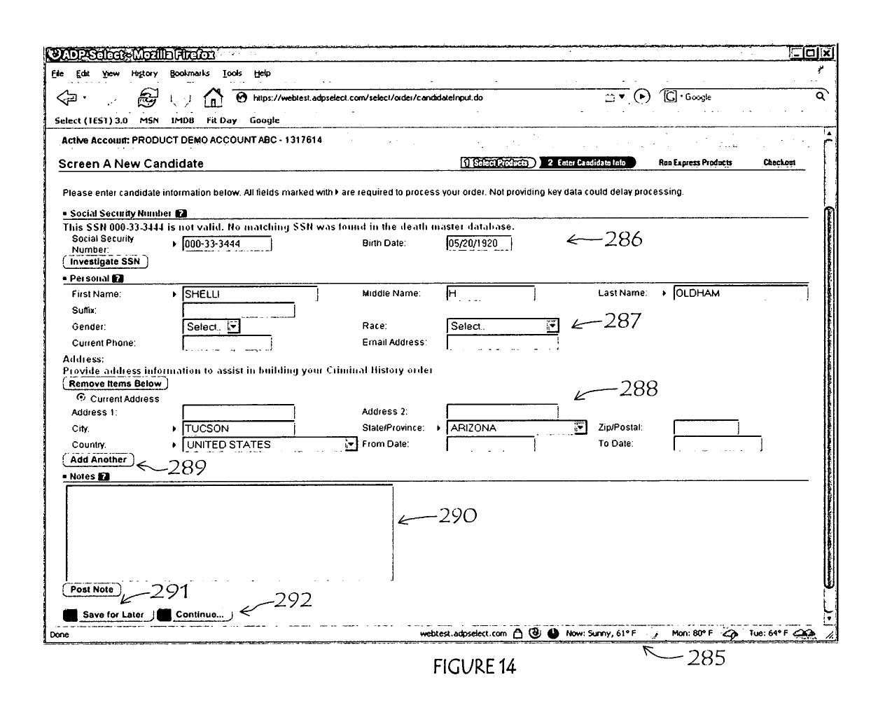

Referring now to FIG. 14 there is shown a screen shot of one embodiment of a candidate entry screen according to the present application. Candidate entry screen 285 is of the type appearing after selection of packages or individual searches in screen a new candidate screen 270. Candidate entry screen 285 allows the user to enter relevant information about a candidate. The candidate's social security number and date of birth can be entered in boxes of Social Security Number section 286. The candidate's name, gender, race, phone number, and e-mail address can be entered in boxes of Personal information section 287. The candidate's address information and start and end dates for living at such address can be added in address section 288. The user can enter additional addresses for the candidate by selection of Add Another button 289 in address section 288. The user is also able to add comments about the candidate in notes text box 290. Once candidate information is entered, the user may invoke searches or delay searches for the entered candidate. To delay searching for the candidate, the user selects Save for Later button 291. To invoke the selected searches for the entered candidate, the user selects Continue button 292.

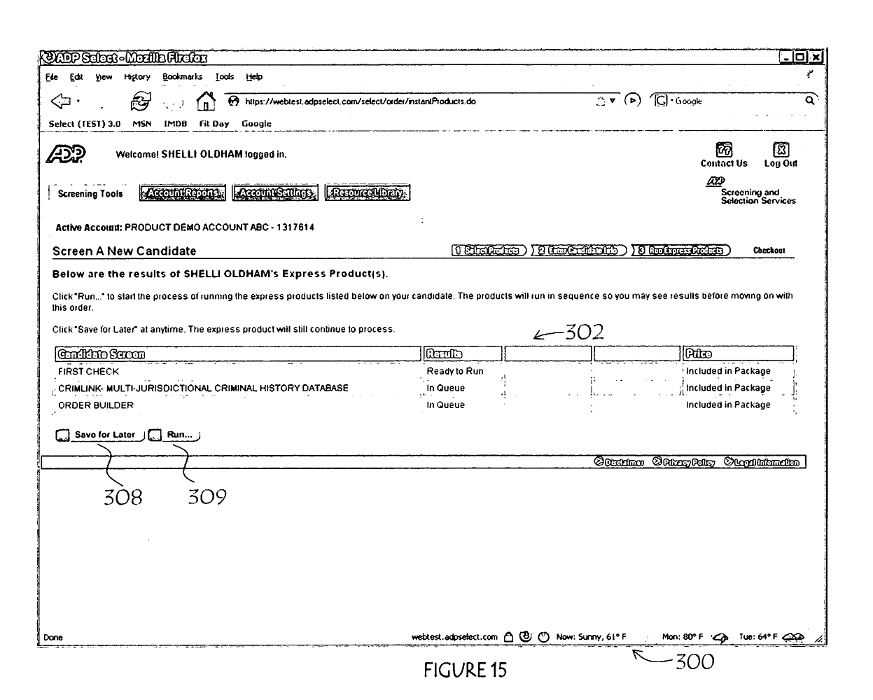

FIG. 15 shows a screen shot of the embodiment of the screen a new candidate screen of FIG. 13 having data filled therein. Screen a new candidate screen 300 is displayed after entry of the desired packages and the candidate information, as discussed herein in association with FIG. 13, and FIG. 14, and allows the user to verify its selections for searches for the candidate. Screen a new candidate screen 300 shows the status of the searches selected for the candidate. In the embodiment shown in FIG. 13, the user selected the criminal risk package containing a criminal risk, SSN validation (First Check), and other (Order Builder) search. Thus, in this FIG. 15, table 302 shows the status of each type of search in the package. In this embodiment, the data source for SSN validation (First Check) is instant, and, therefore, the status of the SSN validation search is indicated as “Ready to Run”. The data source for the criminal risk search is a combination of instant and non-instant sources; therefore, its status is indicated as “In Queue”. The other (Order Builder) search is instant, and its status is also indicated as “In Queue”. Once the user has verified that the correction searches are indicated for the selected candidate, the user may start the searches or delay the searches. If the user desires to delay the searches, the user selects Save for Later button 308. If, on the other hand the user desires to invoke the searches, the user selects Run button 309.

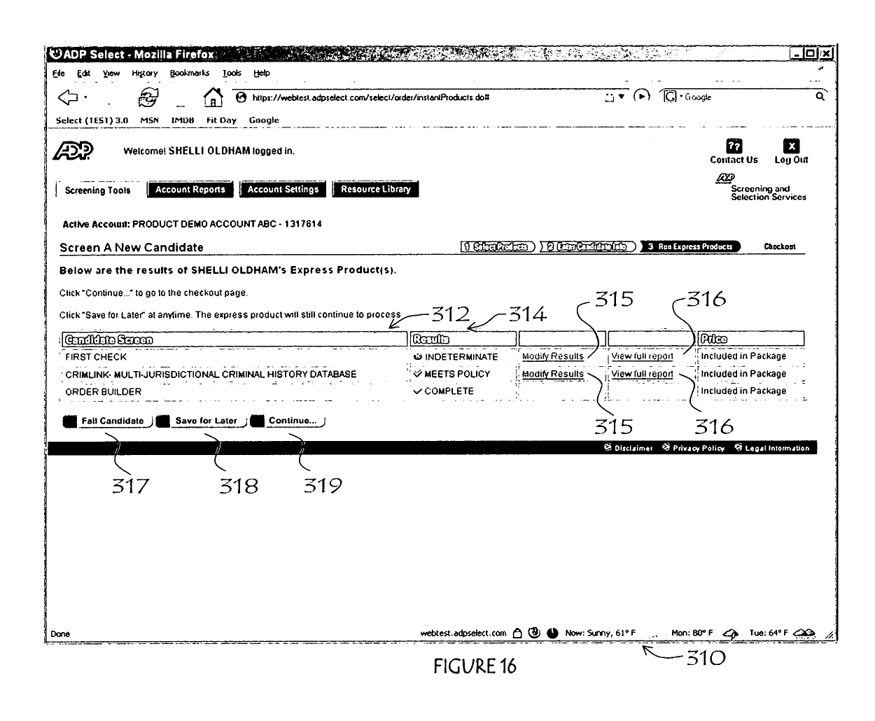

Referring now to FIG. 16 there is shown a screen shot of the embodiment of the screen a new candidate screen of FIG. 15 indicating that results have been determined for certain of the candidates. Screen a new candidate screen 310 is of the type accessed by the user sometime after having entered the desired searches for a candidate and the candidate information. In the embodiment of FIG. 16, search status table 312 shows the results of the various searches in results column 314, allows the user to modify the results a particular search by invoking the respective Modify Results field 315, and allows the user to full the full report by invoking View full report field 316 for a particular search. As shown in search status table 312, the results of the First Check search are “Indeterminate”, the results of the criminal risk search are “Meets Policy”, and the Order Builder search is “Complete.

If the user selects Modify Results field 315 for either the First Check search or the criminal risk search, the user will be given the opportunity to change the results of the report to “Meets Policy”, “Does Not Meet Policy”, or “Indeterminate” if the user has the authority to do so. If the user selects View full report field 316 for either the First Check search or the criminal risk search, the user will be presented with a report (akin to that of FIG. 5) showing the characteristics searched, the results for individual characteristics, and, if applicable, line items under a characteristic, as well as the ratings associated with the line items and characteristics, and the overall rating.

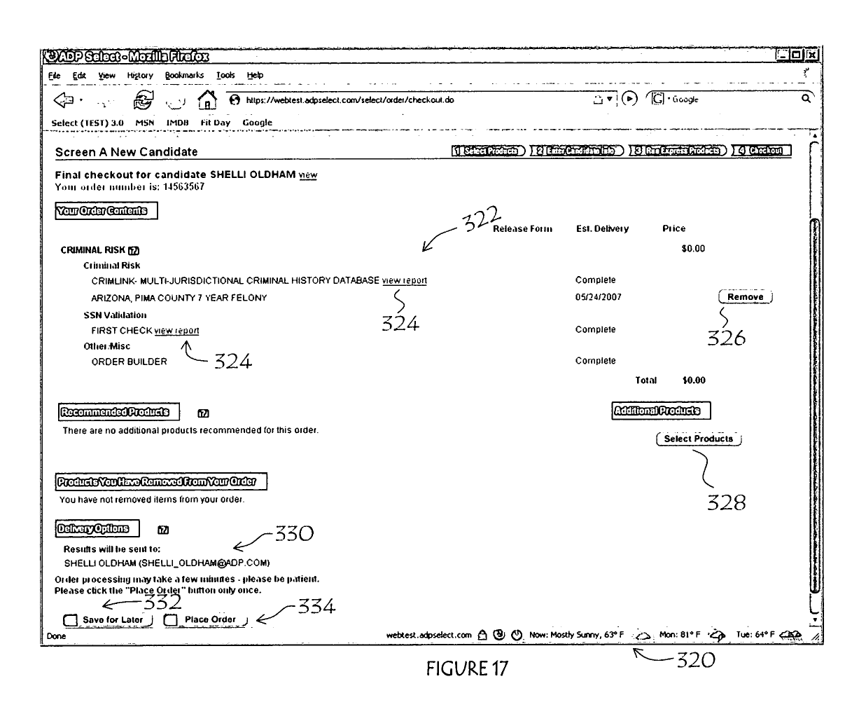

If the user selects Fall Candidate button 317 to request that the service provider initiate the Adverse Action notification service due to the results of the background check, the service provider will notify the candidate as such as in accordance with the Fair Credit Reporting Act. If the user selects Save for Later button 318, the system continues to execute any incomplete searches already ordered and saves the results of the ordered searches when available. If the user selects Continue button 319, the user is taken to an order screen, such as that illustrated in association with FIG. 17 hereof Note that in this embodiment of FIG. 16, the searches are already complete (were already ordered).

FIG. 17 shows a screen shot of one embodiment of an order screen according to the present application. Order screen 320 provides a summary of the results of the screening for the selected candidate. In the embodiment of FIG. 17, status box 322 shows the status of the selected searches. The user may see a more detailed report for completed searches by selecting view report action 324 for the desired search. Selection of Remove button 326 allows the user to remove searches that are not yet complete (all are complete in this example). The system also gives the user the opportunity to perform additional, recommended searches by selection of Select Products button 328. Delivery options are shown in Delivery Options box 330 (note that the user can modify the delivery options). The user can save the order to run later by selecting Save for Later button 332, or place the order for the searches by selecting Place Order button 334.

Note that in the embodiment illustrated in FIG. 17, the searches requested have already been completed. An order screen akin to order screen 320 will be displayed before ruling any searches including those using instant data sources, in normal operation to allow the user the opportunity to order or to modify the order of searches. Order screen 320 also allows the user to order more searches for an existing candidate—to place another other for the candidate.

Referring now to FIG. 18 there is shown a screen shot of the embodiment of the screening tools screen of FIG. 7 showing the status of candidate screening. Screening tools screen 340 shows the status of candidate screening in Candidate Screening Status Text 262. In this embodiment, searches for three candidates are in process, and have been identified as being saved to run later. The user can select to view completed reports by selecting Complete action 341; view those candidates for whom searches are in process by selecting In-Process action 342; view those candidates for which additional information is required by selecting On Hold action 343; continue the screening process (finish placing an order) by selecting Awaiting a decision action 344, view delayed searches (those searches saved for later as discussed earlier herein) by selecting Delayed action 345; and/or view overdue items by selecting Late action 346. Of course, as with the embodiment of FIG. 12, the user may screen a new candidate, search candidates, or continue with saved candidates by selection of Screen a New Candidate action 264, Search Candidates action 266, or Continue with Saved Candidates action 268, respectively.

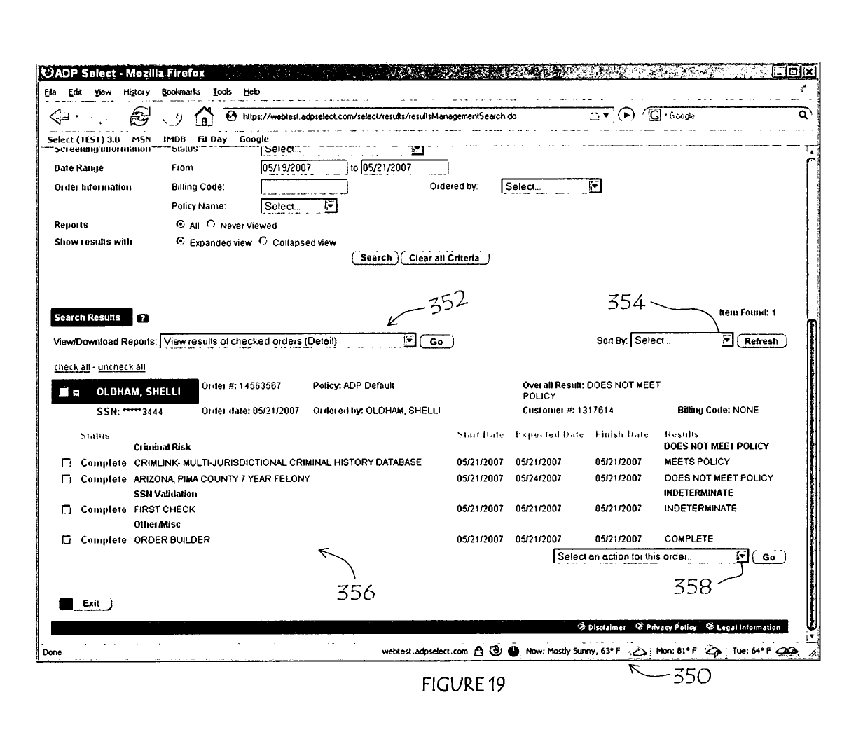

FIG. 19 shows a screen shot of screening search results for a particular candidate according to one embodiment of the invention. By selecting Complete action 341 on screening tools screen 340, the user is presented with information about completed orders. Screening search results screen 350 of FIG. 19 shows an illustration of such a completed order. By the selection of fields available through search results scrollbar 352, the user is able to select the type of report to be shown, and by selection of fields available through sort scrollbar 354, the user is able to specify how the results are to be sorted and displayed. Results table 356 shows the status and overall results for the various types of searches requested. The user may use the fields available on action scrollbar 358 to perform an action for the order. Such actions may include, for example, canceling an incomplete search performing an additional search, requesting Adverse Action Notification, modifying search results (if so authorized), and viewing candidate or order processing notes. By checking a box under the status column of results table 356, the user is able to see the detailed report about the respective search.

As seen in screening search results screen 350, ratings are provided for each search and for the culmination of the various searches. Each search may involve more than one characteristic, and there may be more than one line item for any characteristic. Thus, the ratings shown for a search may be the culmination of ratings for various line items and/or characteristics. Further, the overall rating of DOES NOT MEET POLICY is the culmination of the overall ratings for each search.

The illustrations of FIG. 6 through FIG. 19 utilize screening policies made available by the service provider, i.e., default policies having service provider defined ratings associated with the characteristics searched. In addition to the functions illustrated in FIG. 6 though FIG. 19, as previously discussed, the system allows the user to select and to define various policies. The user is given the capability to establish decision matrices that are reflective of desired policies. As previously discussed herein, the user may define employer specific policies and position specific policies through the establishment of decision matrices therefor. It is also possible that, for a multi-entity employer, decision matrices are shared among the various entities. Such multi-entity employers may include corporate affiliates (parent, subsidiary, common children, etc.) or may include other affiliates (contractors and subcontractors, for example).

While the term “hiring policy” has been used herein in connection with the description of the system and method, this term is not intended to be limited to policies used only for the purpose of hiring an employee. The system and method is applicable to policies for hiring employees, engaging consultants and volunteers retaining employees, consultants, and volunteers, promoting employees, and to amend any previously used policy. For example, the hiring policy for a particular position may change due to change in the law, and it may desirable to ensure that current employees and consultants in such a position comply with the revised hiring policy. provided by the service provider, of the employer's choosing, as required by applicable law, and/or as desired for best practices.

While the present application has been described in detail with reference to certain exemplary embodiments thereof, such are offered by way of non-limiting example of the invention, as other versions are possible. Moreover, a number of design choices exist within the scope of the present application, some of which have been discussed above. It is anticipated that a variety of other modifications and changes will be apparent to those having ordinary skill in the art and that such modifications and changes are intended to be encompassed within the spirit and scope of the invention as defined by the following claims.

It will be appreciated by those of skill in the art that the system and method described herein may be used for more purposes than a pre-screening before engaging (employing or contracting with) a particular candidate. The system and method are also applicable for ensuring that a current employee or current contractor is still considered acceptable, for promotion of an employee or contractor, and/or for applying newly adopted hiring policies, retention policies, new policies, and/or modified policies against its current employees or current contractors.

It will also be appreciated that the system and method allow for collection of screening data from instant (automatic) and non-instant data sources. The acquisition of data from non-instant data sources involve the use of at least one intermediary who receives a request for a search from the system, goes to a remote data source to retrieve the data, and then sends the data back to the system. Because the system will report any screening data made available to it when available, the employer is not required to wait until all relevant data has been retrieved from all data sources to see results for a particular candidate.

It will be further appreciated that, from the employer's perspective, the system and method produce automatic, objective results. The employer does not have to consider whether the desired policy requires collection of data from an instant or non-instant source—to the employer, the results are automatically provided. Also, the employer does not have to manually analyze the results obtained from any of the searches. Instead, ratings are automatically assigned based on the decision matrix.

It will be yet further appreciated that the system and method allows for application of multiple policies to a particular candidate. This gives employers a great deal of flexibility, and the opportunity to consider a candidate for more than one position, or even more than one of the entities with which the employer is associated. Also, various types of characteristics can he handled by the system, with many types of possible values (single value, ranges, time, or other data) associated with that characteristic as a result of a screening search.

It will be still further appreciated that the system and method allow for flexibility in determining the characteristics and the associated ratings to be used for any policy. In this manner, any specific policy can even differ from another policy only in a particular characteristic or only in the rating associated with a particular characteristic. Further, ratings can be established for various line items related to a characteristic, for a characteristic, across several characteristics, and/or across multiple searches. Ratings can also be based on the categories and subcategories of a characteristic. Thus, different weights can effectively be given to different values for different characteristics.

It will be yet still further appreciated that the system of the present application may be made available to employers several different environments. One such environment is an application service environment wherein the user accesses the functionality as resident on a service provider server. In a stand alone environment, the user accesses the functionality on a computing device residing at the employer's designated premises.

As used herein and in the claims, the term “candidate” refers to any candidate for employment, employee, or third party, such as a consultant or volunteer, for whom an employer wishes to check against a certain policy or policies. As used herein and in the claims, the term “employer” refers to any person or entity who may engage others, by employment, by contract, or by volunteerism, for the provision of services. As used herein and in the claims, the term “policy” refers to a screening policy—one used for hiring, promotion, and/or continued engagement of a candidate—with such screening policy based on characteristics and criteria

TABLE 1
APPENDIX A

| | Ability to | | | | | |
|---|---|---|---|---|---|---|
| | Configure/ | | | | | |
| Policy | Customize | | | | | |
| Characteristic | Ratings | Instant | Fixed/Default Value | | | Configurable Value |
| Criminal Risk | Fully | Some | Ratings of: | | | Any combination or counts of offenses from |
| | Configurable | | Does Not Meet Policy: | | | Criminal Risk categories, levels, and |
| | | | a. If one or more offenses for the following | | | descriptions can be mapped to the Ratings of |
| | | | categories at the level of Misdemeanor and with a | | | Meets Policy, Does Not Meet Policy, and |
| | | | disposition of Conviction: | | | Indeterminate |
| | | | Conspiracy/Aid/Collusion (any subcategory) | | | |
| | | | Controlled Dangerous Substances | | | |
| | | | (Drugs/Alcohol (any subcategory) | | | |
| | | | Court Order Violations (any subcategory) | | | |
| | | | Fraud (any subcategory) | | | |
| | | | Immoral/Deviant Acts (any subcategory) | | | |
| | | | Theft (any subcategory) | | | |
| | | | Unlawful Acts Against People (any | | | |
| | | | subcategory) | | | |
| | | | Unlawful Acts Against Property (any | | | |
| | | | subcategory) | | | |
| | | | Weapons (any subcategory) | | | |
| | | | b. If one or more offenses for the following | | | |
| | | | categories at the level of Felony and with a | | | |
| | | | disposition of Conviction: | | | |
| | | | Conspiracy/Aid/Collusion (any subcategory) | | | |
| | | | Controlled Dangerous Substances | | | |
| | | | (Drugs/Alcohol) (any subcategory) | | | |
| | | | Court Order Violations (any subcategory) | | | |
| | | | Fraud (any subcategory) | | | |
| | | | Immoral/Deviant Acts (any subcategory) | | | |
| | | | Misconduct (any subcategory) | | | |
| | | | Theft (any subcategory) | | | |
| | | | Traffic (any subcategory) | | | |
| | | | Unlawful Acts Against People (any | | | |
| | | | subcategory) | | | |
| | | | Unlawful Acts Against Property (any | | | |
| | | | subcategory) | | | |
| | | | Weapons (any subcategory | | | |
| | | | Indeterminate: | | | |
| | | | a. If one of more offenses are found for the level | | | |
| | | | of Felony, Misdemeanor, Non-classifiable - traffic, | | | |
| | | | non-classifiable - ordinance, or non-classifiable - | | | |
| | | | unknown, and with a disposition of non-conviction - | | | |
| | | | arrest/complaint, non-conviction - deferral, non- | | | |
| | | | conviction, or non-conviction - unclassifiable for: | | | |
| | | | Conspiracy/Aid/Collusion (any subcategory) | | | |
| | | | Controlled Dangerous Substances | | | |
| | | | (Drugs/Alcohol) (any subcategory) | | | |
| | | | Court Order Violations (any subcategory) | | | |
| | | | Fraud (any subcategory) | | | |
| | | | Immoral/Deviant Acts (any subcategory) | | | |
| | | | Misconduct (any subcategory) | | | |
| | | | Theft (any subcategory) | | | |
| | | | Traffic (any subcategory) | | | |
| | | | Unlawful Acts Against People (any | | | |
| | | | subcategory) | | | |
| | | | Unlawful Acts Against Property (any | | | |
| | | | subcategory) | | | |
| | | | Weapons (any subcategory) | | | |
| | | | b. If one or more offenses are found for the level | | | |
| | | | of non-classifiable - unknown offense level and | | | |
| | | | with a disposition of non-conviction - | | | |
| | | | arrest/complaint, non-conviction - deferral, | | | |
| | | | conviction, non-conviction, non-conviction - | | | |
| | | | immediate dismissal, or non-conviction - | | | |
| | | | unclassifiable for: | | | |
| | | | Conspiracy/Aid/Collusion (any subcategory) | | | |
| | | | Controlled Dangerous Substances | | | |
| | | | (Drugs/Alcohol) (any subcategory) | | | |
| | | | Court Order Violations (any subcategory) | | | |
| | | | Fraud (any subcategory) | | | |
| | | | Immoral/Deviant Acts (any subcategory) | | | |
| | | | Misconduct (any subcategory) | | | |
| | | | Theft (any subcategory) | | | |
| | | | Traffic (any subcategory) | | | |
| | | | Unlawful Acts Against People (any | | | |
| | | | subcategory) | | | |
| | | | Unlawful Acts Against Property (any | | | |
| | | | subcategory) | | | |
| | | | Weapons (any subcategory) | | | |
| | | | c. If one or more offenses are found at the level | | | |
| | | | of misdemeanor with a disposition of conviction | | | |
| | | | for: | | | |
| | | | Misconduct (any subcategory) | | | |
| | | | Traffic (any category) | | | |
| | | | Meets Policy if none of the above are true, or, for | | | |
| | | | all categories, the level of the offense combined | | | |
| | | | with the disposition is as follows: | | | |
| | | | Level of felony with disposition of non- | | | |
| | | | conviction - immediate dismissal | | | |
| | | | Level of misdemeanor with disposition of | | | |
| | | | non-conviction - immediate dismissal | | | |
| | | | Level of non-classifiable - ordinance with | | | |
| | | | disposition of conviction | | | |
| | | | Level of non-classifiable - ordinance with | | | |
| | | | disposition of non-conviction - immediate | | | |
| | | | dismissal | | | |
| | | | Level of non-classifiable - traffic with | | | |
| | | | disposition of conviction | | | |
| | | | Level of non-classifiable - traffic with | | | |
| | | | disposition of non-conviction - immediate | | | |
| | | | dismissal | | | |
| SSN | Fully | Yes | Ratings of: | | | Client can map each of the following SSN |
| Validation | Configurable | | SSN Issued Prior to Candidate's DOB and SSN | | | Results of: |
| | | | Issued to a Deceased Person = Does Not Meet | | | SSN Issued Prior to Candidate's DOB |
| | | | Policy | | | SSN Issued to a Deceased Person |
| | | | SSN Invalidly Issued = Indeterminate | | | SSN Invalidly Issued |
| | | | SSN Validly Issued = Meets Policy | | | SSN Validly Issued |
| | | | | | | To one of the following Ratings: |
| | | | | | | Meets Policy |
| | | | | | | Does Not Meet Policy |
| | | | | | | Indeterminate |
| Driver Safety | Fully | Some | Ratings of: | | | Any combination, years of inclusion, or |
| Risk | Configurable | | Does Not Meet Policy if have the stated violation | | | counts of Violations can be mapped to the |
| | | | for the # of occurrences within the last # years: | | | Ratings of Meets Policy, Does Not |
| | | | Violation | # | Years | Meet Policy, and Indeterminate |
| | | | Alcohol/Drug Violations | 1 | 3 | |
| | | | At-Fault Accident | 2 | 3 | |
| | | | Unclassified offenses | 1 | 3 | |
| | | | Duties Failed Violations | 3 | 3 | |
| | | | Equipment/Vehicle Violations | 3 | 3 | |
| | | | Maneuvering Violations | 4 | 3 | |
| | | | Moving Violations | 4 | 3 | |
| | | | Speeding Violations | 5 | 3 | |
| | | | Indeterminate if have the stated violation for the # | | | |
| | | | of occurrences within the last # years stated: | | | |
| | | | Violation | # | Years | |
| | | | At-Fault Accident | 1 | 3 | |
| | | | Suspension/Revocation/ | 1 | 3 | |
| | | | Withdraw | | | |
| | | | Withdrawl | 1 | 3 | |
| | | | Duties Failed Violations | 2 | 3 | |
| | | | Equipment/Vehicle Violations | 3 | 3 | |
| | | | Maneuvering Violations | 3 | 3 | |
| | | | Moving Violations | 3 | 3 | |
| | | | Speeding Violations | 3 | 3 | |
| | | | Invalid License | 1 | Now | |

| | | | | |
|---|---|---|---|---|
| | | | Meets Policy if a result other than identified for the | |
| | | | Does Not Meet Policy or Indeterminate ratings | |
| Credit | Fully | Yes | Rating of: | Any combination of counts or years of |
| Worthiness | Configurable | | Does Not Meet Policy if: | inclusion of public records, collection |
| | | | 4 or more previously negative accounts exist OR | accounts, current negative accounts or |
| | | | 2 or more currently negative accounts exist OR | previous negative accounts can be mapped |
| | | | 2 or more collection records in the past 2 years | to the Ratings of Meets Policy, Does Not |
| | | | exist OR | Meet Policy, and Indeterminate |
| | | | 2 or more public or collection record in the past | |
| | | | 2 years exist OR | |
| | | | 2 or more public records exist | |
| | | | Indeterminate If: | |
| | | | 2 or more previously negative accounts exist OR | |
| | | | 1 or more currently negative accounts exist OR | |
| | | | 1 or more collection records in the past 2 years | |
| | | | exist OR | |
| | | | 1 or more public records exist | |
| | | | Meet Policy for all other results | |
| Reference | Semi- | No | Results of: | Client can map each of the following |
| Vertification | Configurable | | Derogatory and Info Difference = Does Not Meet | Reference Results of: |
| | | | Policy | Derogatory |
| | | | No Listing, Request Cancelled, and Unable to | Info Difference |
| | | | Verify = Indeterminate | No Listing |
| | | | Verified = Meet Policy | Request Cancelled |
| | | | | Unable to Verify |
| | | | | Verified |
| | | | | To one of the following Ratings: |
| | | | | Meets Policy |
| | | | | Does Not Meet Policy |
| | | | | Indeterminate |
| Bankruptcy | Non- | No | Record = Indeterminate | N/A |
| Risk | Configurable | | No Record = Meets Policy | |
| Civil Risk | Non- | No | Record = Indeterminate | N/A |
| | Configurable | | No Record = Meets Policy | |
| Sexual | Non- | No | Record = Indeterminate | N/A |
| Offender Risk | Configurable | | No Record = Meets Policy | |
| Government | Non- | No | Record = Indeterminate | N/A |
| Sanctions Risk | Configurable | | No Record = Meets Policy | |
| Workers | Non- | No | Record = Indeterminate | N/A |
| Comp Risk | Configurable | | No Record = Meets Policy | |
| Job Fit | Non- | Yes | Good Fit = Meets Policy | N/A |
| Assessment | Configurable | | Manageable Fit = Indeterminate | |
| | | | Questionable Fit − Indeterminate | |

We claim:

1. A system for evaluating a candidate based on a predefined policy, the system comprising:
a processor;
data storage means operably connected to the processor, the data storage means capable of storing a decision matrix representative of the predefined policy, wherein the decision matrix comprises a characteristic for evaluation of the candidate and at least one rating for the characteristic with such rating based on the characteristic, and the data storage means capable of storing data representative of the candidate, and
a data source operably connected to the processor, the data source capable of providing to the processor data representative of the characteristic based on the data representative of the candidate,
wherein the processor is operable to compare the data representative of the characteristic provided by the data source to the characteristic of the decision matrix and to determine the corresponding at least one rating for the characteristic based on such comparison.

2. The system of claim 1, wherein the data source comprises a data source processor.

3. The system of claim 1, wherein the data source comprises an input device operably connected to the processor of the system and a remote data source, wherein the remote data source contains the data representative of the characteristic based on the data representative of the candidate, and wherein such data representative of the characteristic is retrieved from the remote data source and input into the input device of the data source.

4. The system of claim 1, wherein the characteristic of the decision matrix stored on the data storage means consists of at least one from the group of job fitness, bankruptcy risk, credit worthiness, criminal risk, civil risk, social security number verification, driver safety, reference verification, sexual harassment risk, workers' compensation risk, terrorist alert, retail theft, drug testing, international criminal risk, and identity.

5. The system of claim 1, where in the ratings consist of at least one of the group comprising meets policy, does not meet policy, and indeterminate.

6. The system of claim 1, farther comprising:
a user system in bidirectional communication with the processor, the user system for entry of the data representative of the candidate and for presentation of the determination of the at least one rating.

7. The system of claim 6, wherein the user system is further operable to accept input from a user to establish the decision matrix.

8. The system of claim 1, wherein the at least one rating for the characteristic of the decision matrix stored on the data storage means is based on possible value(s) of the characteristic provided for the candidate from the data source.

9. The system of claim 1, wherein the at least one rating for the characteristic of the decision matrix stored on the data storage means is based on a range of possible values of the data representative of the characteristic provided for the candidate from the data source.

10. The system of claim 1, wherein the data representative of the characteristic provided for the candidate from the data source comprise at least one predetermined value.

11. The system of claim 10, wherein the at least one rating for the characteristic is(are) preset by the system based on the at least one predetermined values for the characteristic.

12. The system of claim 10, further comprising an input device operably connected to the processor, and wherein the at least one rating for the characteristic is(are) editable by a user of the system by use of such input device.

13. The system of claim 1, wherein the data representative of the candidate comprises a first data relevant to the characteristic and a second data relevant to the characteristic, wherein the data representative of the characteristic provided by the data source includes a first data representative of the characteristic based on the first data relevant to the characteristic and a second data representative of the characteristic based on the second data relevant to the characteristic, and wherein the at least one rating for the characteristic comprises a first rating based on the first data representative of the characteristic and a second rating based on the first data representative of the characteristic, and wherein the processor is further operable to determine the first rating and the second rating.

14. The system of claim 13, wherein the at least one rating for the characteristic further comprises a third rating based on the first rating and the second rating, and the processor is further operable to determine the third rating.

15. A system for evaluating a candidate based on a predetermined policy, the system comprising:
a user system;
a processor in bidirectional communication with the user system;
a data storage means operably connected to the processor, the data storage means capable of storing data representative of the candidate and a decision matrix representative of the predetermined policy, the decision matrix comprising a characteristic and at least one rating associated with the characteristic; and
a data source in bidirectional communication with the processor, the data source capable of receiving the data representative of the candidate and returning to the processor at least one value representative of the characteristic of the decision matrix for the candidate,
wherein the processor is operable to compare the at least one value representative of the characteristic of the decision matrix to the at least one rating for the characteristic to determine a calculated rating, and sending the calculated rating to the user system.

16. The system of claim 15, wherein the user system and the processor collectively comprise a computing device.

17. A system for evaluating a candidate based on a predefined policy, the system comprising:
a user system;
a processor in bidirectional communication with the user system;
a data storage means operably connected to the processor, the data storage means capable of storing data representative of the candidate and a decision matrix representative of the predetermined policy, the decision matrix comprising a first characteristic and at least one rating associated with the first characteristic, and the decision matrix comprising a second characteristic and at least one rating associated with the second characteristic;
a first data source in bidirectional communication with the processor, the first data source capable of receiving the data representative of the candidate and returning to the processor at least one value representative of the first characteristic of the decision matrix for the candidate; and
a second data source, the second data source comprising an input device in communication with the processor and a remote data source, the remote data source being searchable by an intermediary for data representative of the second characteristic of the decision matrix to yield at least one value representative of the second characteristic for the candidate, and the input device of the second data source capable of receiving the data representative of the candidate and returning to the processor at least one value representative of the second characteristic of the decision matrix for the candidate,
wherein the processor is operable to compare the at least one value representative of the first characteristic of the decision matrix to the at least one rating for the first characteristic to determine a first calculated rating, to compare the at least one value representative of the second characteristic of the decision matrix received from the input device of the second data source to the at least one rating for the second characteristic to determine a second calculated rating, and sending the first calculated rating and the second calculated rating to the user system.

18. The system of claim 17, wherein the processor is further operable to create a combined rating from the first calculated rating and the second calculated rating and sending the combined rating to the user system.

19. The system of claim 17, wherein the user system and the processor collectively comprise a computing device.

20. A system for evaluating a candidate based on a predetermined policy, the system comprising:
a processor;
data storage means operably connected to the processor, the data storage means capable of storing a decision matrix representative of the predefined policy, wherein the decision matrix comprises a characteristic for evaluation of the candidate and at least one rating for the characteristic with such rating based on the characteristic, and the data storage means capable of storing data representative of the candidate;
a first data source operably connected to the processor, the first data source capable of providing the processor with first data representative the characteristic based on the data representative of the candidate; and
a second data source operably connected to the processor, the second data source capable of providing to the processor with second data representative of the characteristic based on the data representative of the candidate,
wherein the processor is operable to compare the first data representative of the characteristic provided by the first data source to the characteristic of the decision matrix, to compare the second data representative of the characteristic provided by the second data source to the characteristic of the decision matrix, and to determine the corresponding at least one rating for the characteristic based on such comparison.

21. The system of claim 20, wherein
the first data source is in bidirectional communication with the processor and is capable of receiving the data representative of the candidate and returning to the processor the first data representative of the characteristic for the candidate, and
wherein the second data source is in bidirectional communication with the processor and is capable of receiving the data representative of the candidate and returning to the processor the second data representative of the characteristic of the candidate and returning to the processor the second data representative of the characteristic for the candidate.

22. The system of claim 20, wherein
the first data source is in bidirectional communication with the processor and is capable of receiving the data representative of the candidate and returning to the processor the first data representative of the characteristic for the candidate, and
wherein the second data source comprises an input device and a remote data source, the remote data source being searchable by an intermediary for data representative of the characteristic of the decision matrix based on the data representative of the candidate, the input device of the second data source capable of receiving the data representative of the candidate and returning to the processor the second data representative of the characteristic of the decision matrix for the candidate.

23. The system of claim 20, wherein
the first data source comprises a first input device and a first remote data source, the first remote data source being searchable by a first intermediary for data representative of the characteristic of the decision matrix based on the data representative of the candidate to yield the first data representative of the characteristic for the candidate, the first input device capable of receiving the data representative of the candidate and returning to the processor the first data representative of the characteristic of the decision matrix for the candidate, and
wherein the second data source comprises a second input device and a second remote data source, the second remote data source being searchable by a first intermediary for data representative of the characteristic of the decision matrix based on the data representative of the candidate to yield the second data representative of the characteristic for the candidate, the second input device capable of receiving the data representative of the candidate and returning to the processor the second data representative of the characteristic of the decision matrix for the candidate.

24. The system of claim 20, wherein the first data representative of the characteristic for the candidate and the second data representative of the characteristic for the candidate are provided to the processor at approximately at the same time.

25. The system of claim 20, wherein the first data representative of the characteristic for the candidate is provided to the processor at a different time than the second data representative of the characteristic for the candidate is provided to the processor.

26. A system for evaluating a candidate based on a predetermined policy, the system comprising:
a processor;
a data storage means operably connected to the processor, the data storage means capable of storing data representative of the candidate and a decision matrix representative of the predetermined policy, the decision matrix comprising a plurality of characteristics, each of the plurality of characteristics having associated therewith at least one rating; and
at least one data source operably connected to the processor, each of the at least one data sources capable of providing to the processor data representative of at least one of the plurality of characteristics based on the data representative of the candidate,
wherein the processor is operable to compare the data representative of the at least one characteristics provided by each of the at least one data sources to the corresponding characteristic(s) of the decision matrix and to determine the corresponding at least one ratings for each of the plurality of characteristics based on such comparison.

27. The system of claim 26, wherein the processor is further operable to combine the at least one ratings for each of the plurality of characteristics into an overall rating for the plurality of characteristics.

28. A system for evaluating a candidate based on a first predetermined policy and a second predetermined policy, the system comprising:
a processor;
a data storage means operably connected to the processor, the data storage means capable of storing a first decision matrix representative of the first predefined policy, wherein the first decision matrix comprises a first characteristic for evaluation of the candidate and a first rating for the first characteristic with such first rating based on the first characteristic, the data storage means also capable of storing a second decision matrix representative of the second predefined policy, wherein the second decision matrix comprises a second characteristic for evaluation of the candidate and a second rating for the second characteristic with such second rating based on the second characteristic, and the data storage means further capable of storing data representative of the candidate; and
at least one data source operably connected to the processor, the at least data source capable of providing to the processor data representative of the first characteristic based on the first data representative of the candidate and data representative of the second characteristic based on the second data representative of the candidate,
wherein the processor is operable to compare the first data representative of the first characteristic provided by the at least one data source to the first characteristic of the first decision matrix, to compare the second data representative of the second characteristic provided by the at least one data source to the second characteristic of the second decision matrix, and to determine the first rating for the first characteristic and the second rating for the second characteristic based on such comparison.

29. The system of claim 28, wherein the processor is further operable to determine a third rating from the first rating and the second rating.

30. A system for evaluating a candidate based on a predetermined policy, the system comprising:
a user system for entry of candidate information and for invoking a first search and a second search;
a processor in bidirectional communication with the user system;
a data storage means operably connected to the processor, the data storage means operable to store candidate information and at least one decision matrix, each of the at least one decision matrices including at least one characteristic and at least one rating based on the at least one character; and
at least one data source capable of returning first data representative of the candidate based on the first search and on the candidate information and corresponding to at least one of characteristics of the at least one decision matrices, and returning second data representative of the candidate based on the second search and on the characteristics of the candidate information and corresponding to at least one of the characteristics of at least one of the at least one decision matrices,
wherein the processor is operable to send the first search to at least one of the at least one data sources for retrieval of the first data representative of the candidate, to send the second search to at least one of the at least one data sources for retrieval of the second data representative of the candidate, to determine at least one first rating for the first search based on the at least one rating of at least one of the at least one decision matrices, and to determine at least one second rating for the second search based on the at least one rating of at least one of the at least one decision matrices.

31. The system of claim 30, wherein the processor is further operable to determine a third rating from the first rating and the second rating.

32. The system of claim 30, wherein the user system and processor collectively comprise a computing device.

33. A system for evaluating a candidate in view of a plurality of predetermined policies, the system comprising:
a processor;
data storage means operably connected to the processor, the data storage means capable of storing a plurality of decision matrices, each decision matrix representative of one of the plurality of predefined policies, wherein each of the plurality of decision matrices comprises at least one characteristic for evaluation of the candidate and at least one rating associated with the at least one characteristic of that decision matrix, and the data storage means capable of storing data representative of the candidate; and
at least one data source operably connected to the processor, each of the at least one data sources capable of providing to the processor data representative of one of the at least one characteristics of at least one of the plurality of decision matrices characteristic on the data representative of the candidate,
wherein the processor is operable to compare the representative data provided by the at least one data sources to the corresponding at least one characteristic of the plurality of decision matrices and to determine the corresponding at least one rating therefor based on such comparison.

34. The system of claim 33, wherein one of the plurality of decision matrices comprises a matrix representative of a general policy.

35. The system of claim 33, wherein one of the plurality of decision matrices comprises a matrix representative of a policy specific to the employer.

36. The system of claim 33, wherein one of the plurality of decision matrices comprises a matrix representative of a policy specific to a position.

37. The system of claim 33, wherein one of the plurality of decision matrices comprises a matrix representative of a policy determined by applicable law.

38. The system of claim 33, wherein one of the plurality of decision matrices comprises a matrix representative of a policy of best practices.

39. The system of claim 33, wherein one of the plurality of decision matrices is defined by a service provider.

40. The system of claim 33, wherein one of the plurality of decision matrices is defined by an employer.

41. The system of claim 33, wherein the one of the plurality of decision matrices is defined by a service provider and by an employer.

42. A method for evaluating a candidate based on a predetermined policy, the method comprising the steps of:
(a) providing a system comprising a processor, a data storage means operably connected to the processor, and a data source operably connected to the processor, wherein
the data storage is capable of storing a decision matrix representative of the predefined policy, wherein the decision matrix comprises a characteristic for evaluation of the candidate and at least one rating for the characteristic with such rating based on the characteristic, and the data storage means capable of storing data representative of the candidate, and
the data source is capable of providing to the processor data representative of the characteristic based on the data representative of the candidate;
(b) with the processor, retrieving from the data storage means the candidate information and the decision matrix;
(c) sending from the processor to the data source a request to search for data representative of the characteristic based on the data representative of the candidate;
(d) receiving at the processor the data representative of the characteristic based on the data representative of the candidate;
(e) comparing with the processor the data representative of the characteristic provided by the data source to the characteristic of the decision matrix; and
(f) determining with the processor the corresponding at least one rating for the characteristic.

43. The method of claim 42, wherein the system further comprises a presenting means, and wherein the method further comprises the step of:
(g) presenting with the presenting means the at least one rating for the characteristic determined in step (f).

44. A method for evaluating a candidate based on a predetermined policy, the method comprising the steps of:
(a) providing a system including a user system, a processor in bidirectional communication with the user system, a data storage means operably connected to the processor, and a data source in bidirectional communication with the processor, wherein
the user system comprises a input device and an output device,
the data storage means is capable of storing data representative of the candidate and a decision matrix representative of the predetermined policy, the decision matrix comprising a characteristic and at least one rating associated with the characteristic, and
the data source is capable of receiving the data representative of the candidate and returning to the processor at least one value representative of the characteristic of the decision matrix for the candidate;
(b) entering data representative of the candidate with the user system;
(c) with the processor, retrieving from the data storage means the candidate information and the decision matrix;
(d) sending from the processor to the data source a request to search for data representative of the characteristic based on the data representative of the candidate;
(e) receiving at the processor the data representative of the characteristic based on the data representative of the candidate;
(f) comparing with the processor the data representative of the characteristic provided by the data source to the characteristic of the decision matrix; and
(g) determining with the processor the corresponding at least one rating for the characteristic.

45. The method of claim 44, further comprising the step of:
(h) sending to the presenting means of the user system the at least one rating for the characteristic determined in step (g).

46. The method of claim 44, further comprising, before step (c), the step of:
entering with the user system the decision matrix into the data storage means.

47. The method of claim 44, further comprising, before step (c), the step of:
entering with the user system the at least one rating associated with the decision matrix.
